(19) United States
(12) Patent Application Publication
(10) Pub. No.: US 2015/0363798 A1
(43) Pub. Date: Dec. 17, 2015

(54) METHOD, COMPUTER SYSTEM AND COMPUTER PROGRAM FOR ESTIMATING PURCHASE BEHAVIOR OF CUSTOMER IN STORE OR ACROSS STORES

(71) Applicant: International Business Machines Corporation, Armonk, NY (US)

(72) Inventors: Toru Aihara, Yokohama (JP); Noboru Kamijo, Fujisawa (JP); Takayuki Osogami, Yamato (JP); Shunichi Amano, Yamato (JP)

(21) Appl. No.: 14/732,052

(22) Filed: Jun. 5, 2015

(30) Foreign Application Priority Data
Jun. 16, 2014 (JP) 2014-123267

(51) Int. Cl. G06Q 30/02; G06F 17/30

(52) U.S. Cl. CPC G06Q 30/0201; G06F 17/30876

(57) ABSTRACT

A technique that can estimate purchase behavior of a customer in a store is provided. The technique includes acquiring article information on at least one article that a target customer purchases in the store, and layout information on each store and shelving allocation information on each store. The technique includes reading at least one of previous path information on actual travel of one or more customers in the store, and previous path information on actual travel of the target customer in the store or across the stores. The technique includes estimating a traffic line of the target customer in the store or across the stores, according to a tendency acquired from the path information read, based on each piece of the information acquired.

### CROSS-REFERENCE TO RELATED APPLICATIONS

This application claims priority to Japanese Patent Application No. 2014123267, filed Jun. 16, 2014, which is incorporated herein in its entirety.

### BACKGROUND

The present invention relates to a technique that estimates purchase behavior of a customer. In particular, the present invention relates to a technique that estimates a traffic line of a customer in a store or across stores.

In recent years, multi-channel and omni-channel mechanisms that integrate systems used in actual stores and EC sites, deliver information on articles demanded by customers and perform marketing and promotion by utilizing a mobile system typified by a smart phone or a tablet terminal have begun to be examined.

In Internet electronic commerce in rapidly wide-spreading electronic commerce (EC) sites, purchase behavior of customers can be easily grasped. For instance, it can be easily analyzed which article is seen and what order the article is purchased.

On the contrary, an actual store for transactions using point-of-sale (POS) only register articles scanned during checkout by a POS terminal, and the order of scanning. There is no way to determine how a customer travels in a store and what order the customer purchases what article. Accordingly, unlike at an EC site, the conventional method cannot acquire data sufficient to analyze the purchase behavior of a customer.

Thus, in the conventional retail industry, a primitive method that records the shopping behavior of a customer on video and then has an interview has been typical. Measures have been taken to convert such materials into IT content using a monitoring camera and IC tags. Unfortunately, even with a large amount of investment, this scheme lacks in correctness. Accordingly, the measures have not been widespread yet.

### SUMMARY

The present invention provides a technique of estimating purchase behavior of a customer. This technique may involve a method of estimating purchase behavior of a customer, a computer system that estimates purchase behavior of a customer, and a computer program that estimates purchase behavior of a customer and a computer program product thereof.

In a first embodiment according to the present invention, a method of estimating purchase behavior of a customer in a store or across stores, the method causing a computer system to execute the steps of acquiring article information on at least one article that a target customer purchases or tries to purchase in the store or across the stores, layout information on each store, and shelving allocation information on each store; reading at least one of: previous path information on actual or estimated travel of one or more customers in the store or across the stores, and previous path information on actual or estimated travel of the target customer in the store or across the stores; and estimating a traffic line of the target customer in the store or across the stores, according to a tendency acquired from the path information read in reading, based on each piece of the information acquired in the acquiring.

In a second embodiment according to the present invention, a method of estimating purchase behavior of a customer in a store or across stores, the method causing a computer system to execute the steps of: acquiring article information on at least one article that a target customer purchases or tries to purchase in the store or across the stores, layout information on each store, and shelving allocation information on each store, the article information being acquired from an apparatus associated with the target customer and consisting of identification information on the at least one article that the target customer purchases or tries to purchase, and time information when the identification information is read; reading at least one of: previous path information on actual or estimated travel of one or more customers in the store or across the stores, and previous path information on actual or estimated travel of the target customer in the store or across the stores; and calculating position information on the target customer and time information when the target customer is at each position, based on the identification information on the at least one article that the target customer purchases or tries to purchase, the time information when the identification information is read, and the layout information or the shelving allocation information, and estimating a traffic line of the target customer in the store or across the stores, according to a tendency acquired from the path information read in the reading, based on each piece of the information acquired in the acquiring, and the position information and the time information calculated for the target customer.

In one of the second embodiment according to the present invention, the estimating the traffic line may include the steps of calculating an average travel speed between two points in the store or across the stores, based on the path information read in the reading, and estimating the traffic line of the target customer using the position information and the time information calculated for the target customer, such that the travel speed of the target customer between the two points in the store or across the stores approaches the calculated average speed.

In one of the second embodiment according to the present invention, the path information read in the reading may be divided into a set of partial paths, and the estimating the traffic line may include the steps of: calculating a weight for a path cost that describes the set of partial paths most appropriately, and estimating a path of the target customer connecting two points in the store or across the stores, using the weight for the path cost, and the position information and the time information calculated for the target customer.

In one of the second embodiment according to the present invention, the step of estimating the path may include a step of estimating a path minimizing the weighted path cost as the traffic line of the target customer by solving a shortest path problem. In one of the second embodiment according to the present invention, the step of estimating the path may further include a step of, in a case where the same articles X are arranged at different places and the target customer makes purchase in an order of an article A, an article X, and an article B, estimating that the target customer tries to purchase the article X at a place minimizing a sum of a path cost from a place where the target customer tries to purchase the article A to a place where the target customer tries to purchase the article X and a path cost from the place where the target customer tries to purchase the article X to a place where the target customer tries to purchase the article B.

In one of the second embodiment according to the present invention, the set of the partial paths may be at least one of sets of (1) a partial path from an entrance or a cart or basket depot of the store to a position where the target customer tries to purchase a certain article first, (2) a partial path from a position where the target customer tries to purchase a certain article to a position where the target customer tries to purchase a next article, and (3) a partial path from a position where the target customer tries to purchase a certain article lastly to a checkout place or an article receiving counter of the store, or an exit or a cart or basket depot of the store.

In one of the second embodiment according to the present invention, the estimating the traffic line may further include the steps of: calculating position information on the target customer and time information when the target customer is at each position, based on the identification information on the at least one article that the target customer purchases or tries to purchase and the time information when the identification information is read, which are acquired from the apparatus associated with the target customer, and the layout information or the shelving allocation information, comparing the position information and the time information calculated with the path information read in the reading, and extracting path information having high similarity, and estimating the traffic line of the target customer in the store or across the stores, based on the extracted path information.

In one of the second embodiment according to the present invention, the estimating the traffic line may include a step of, in a case where pieces of the path information representing different travel paths having high similarity are extracted, estimating the traffic line of the target customer in the store or across the stores, based on the path information representing the traffic line frequently included in the path information.

In one of the second embodiment according to the present invention, the estimating the traffic line may include a step of, in a case where pieces of the path information representing different travel paths having high similarity are extracted, selecting path information on the target customer more preferentially than path information on other customers, and estimating the traffic line of the target customer in the store or across the stores, based on the selected path information.

In one of the second embodiment according to the present invention, the estimating the traffic line may include a step of, in a case where pieces of the path information representing different travel paths having high similarity are extracted, preferentially selecting path information on one or more customers with an identical or similar shopping category or purchased article, and estimating the traffic line of the target customer in the store or across the stores, based on the selected path information.

In one of the second embodiment according to the present invention, the estimating the traffic line may include a step of, in a case where pieces of the path information representing different travel paths having high similarity are extracted, preferentially selecting path information on one or more customers with age, gender, or travel speed identical or similar to that of the target customer, and estimating the traffic line of the target customer in the store or across the stores, based on the selected path information.

In one of the second embodiment according to the present invention, the estimating the traffic line may include the steps of in response to no travel path with high similarity being extracted by the comparison, comparing a travel path with a shopping point of the acquired travel path reduced at least by one with the path information read in the reading, and extracting path information representing a travel path having high similarity, and estimating the traffic line of the target customer in the store or across the stores, based on the extracted path information. In one of the second embodiment according to the present invention, the estimating the traffic line may further include a step of modifying at least one of the layout information on each store and the shelving allocation information on each store, in response to occurrence of a gap in description of the purchase behavior of the target customer based on the travel path extracted by the comparison.

In a third embodiment according to the present invention, a method of estimating purchase behavior of a customer in a store or across stores, the method causing a computer system to execute the steps of: acquiring article information on at least one article that a target customer purchases in the store or across the stores, layout information on each store, and shelving allocation information on each store, the article information being identification information on the at least one article that the target customer purchases; acquiring position information on the target customer and time information when the target customer is at each position, from an apparatus installed in the store or across the stores or an apparatus associated with the target customer; reading at least one of: previous path information on actual or estimated travel of one or more customers in the store or across the stores, and previous path information on actual or estimated travel of the target customer in the store or across the stores; and acquiring a travel path of the target customer in the store or across the stores from each piece of the information acquired in the acquiring step, and the layout information or the shelving allocation information, estimating at least one purchase order of the at least one article that the target customer purchases, based on each piece of the information acquired in the acquiring step, and the acquired travel path, and estimating a traffic line of the target customer in the store or across the stores, according to a tendency acquired from the path information read in the reading step, based on each piece of the information acquired in the acquiring step.

In one of the third embodiment according to the present invention, the step of estimating the traffic line may further include a step of calculating the position information on the target customer and the time information when the target customer is at each position, based on the acquired travel path and the estimated purchase order, and the step of estimating the traffic line may include a step of estimating the traffic line of the target customer in the store or across the stores, according to the tendency acquired from the path information read in the reading step, based on each piece of information acquired in the acquiring step, and the position information and the time information calculated for the target customer.

In one of the third embodiment according to the present invention, the step of estimating the traffic line may include the steps of calculating an average travel speed between two points in the store or across the stores, based on the path information read in the reading step, and estimating the traffic line of the target customer using the position information and the time information calculated for the target customer, such that the travel speed of the target customer between the two points in the store or across the stores approaches the calculated average speed.

In one of the third embodiment according to the present invention, the path information read in the reading step may be divided into a set of partial paths, and the step of estimating the traffic line may include the steps of calculating a weight for a path cost that describes the set of partial paths most appropriately, and estimating a path of the target customer connecting two points in the store or across the stores, using the weight for the path cost, and the position information and the time information calculated for the target customer.

In one of the third embodiment according to the present invention, the step of estimating the path may include a step of estimating a path minimizing the weighted path cost as the traffic line of the target customer by solving a shortest path problem.

In one of the third embodiment according to the present invention, the step of estimating the path may further include a step of, in a case where the same articles X are arranged at different places and the target customer makes purchase in an order of an article A, an article X, and an article B, estimating that the target customer tries to purchase the article X at a place minimizing a sum of a path cost from a place where the target customer tries to purchase the article A to a place where the target customer tries to purchase the article X and a path cost from the place where the target customer tries to purchase the article X to a place where the target customer tries to purchase the article B.

In one of the third embodiment according to the present invention, the set of the partial paths may be at least one of sets of (1) a partial path from an entrance, or a cart or basket depot of the store to a position where the target customer tries to purchase a certain article first, (2) a partial path from a position where the target customer tries to purchase a certain article to a position where the target customer tries to purchase a next article, and (3) a partial path from a position where the target customer tries to purchase a certain article lastly to a checkout place of the store, an exit, or a cart or basket depot of the store.

In one of the third embodiment according to the present invention, the step of estimating the traffic line may include the steps of: comparing the acquired travel path with the path information read in the reading step, and extracting path information representing the travel path having high similarity; and estimating the traffic line of the target customer in the store or across the stores, based on the extracted path information.

In one of the third embodiment according to the present invention, the step of estimating the traffic line may include a step of, in a case where pieces of the path information representing different travel paths having high similarity are extracted, estimating the traffic line of the target customer in the store or across the stores, based on the path information representing the traffic line frequently included in the path information.

In one of the third embodiment according to the present invention, the step of estimating the traffic line may include a step of, in a case where pieces of the path information representing different travel paths having high similarity are extracted, selecting path information on the target customer more preferentially than path information on other customers, and estimating the traffic line of the target customer in the store or across the stores, based on the selected path information.

In one of the third embodiment according to the present invention, the step of estimating the traffic line may include a step of, in a case where pieces of the path information representing different travel paths having high similarity are extracted, preferentially selecting path information on one or more customers with an identical or similar shopping category or purchased article, and estimating the traffic line of the target customer in the store or across the stores, based on the selected path information.

In one of the third embodiment according to the present invention, the step of estimating the traffic line may include a step of, in a case where pieces of the path information representing different travel paths having high similarity are extracted, preferentially selecting path information on one or more customers with age, gender, or travel speed identical or similar to that of the target customer, and estimating the traffic line of the target customer in the store or across the stores, based on the selected path information.

In one of the third embodiment according to the present invention, the step of estimating the traffic line may include the steps of in response to no travel path with high similarity being extracted by the comparison, comparing a travel path with a shopping point of the acquired travel path reduced at least by one with the path information read in the reading step, and extracting path information representing a travel path having high similarity, and estimating the traffic line of the target customer in the store or across the stores, based on the extracted path information.

In one of the third embodiment according to the present invention, the step of estimating the traffic line may further include a step of modifying at least one of the layout information on each store and the shelving allocation information on each store, in response to occurrence of a gap in description of the purchase behavior of the target customer based on the travel path extracted by the comparison.

In a fourth embodiment according to the present invention, a computer system estimating purchase behavior of a customer in a store or across stores, includes: an information acquisition unit of acquiring article information on at least one article that a target customer purchases or tries to purchase in the store or across the stores, layout information on each store, and shelving allocation information on each store; a path information reading unit of reading at least one of previous path information on estimated travel of one or more customers in the store or across the stores, and previous path information on estimated travel of the target customer in the store or across the stores; and a traffic line estimation unit of estimating a traffic line of the target customer in the store or across the stores, according to a tendency acquired from the path information read by the path information reading unit, based on each piece of the information acquired by the information acquisition unit.

In a fifth embodiment according to the present invention, a computer system estimating purchase behavior of a customer in a store or across stores, includes: an information acquisition unit of acquiring article information on at least one article that a target customer purchases or tries to purchase in the store or across the stores, layout information on each store, and shelving allocation information on each store, the article information being acquired from an apparatus associated with the target customer and consisting of identification information on the at least one article that the target customer purchases or tries to purchase, and time when the identification information is read; a path information reading unit of reading at least one of previous path information on actual or estimated travel of one or more customers in the store or across the stores, and previous path information on actual or estimated travel of the target customer in the store or across the stores; and a traffic line estimation unit of calculating position information on the target customer and time when the target customer is at each position, based on the identification information on the article that the target customer purchases or tries to purchase, the time information when the identification information is read, which are acquired from the apparatus associated with the target customer, and the layout information or the shelving allocation information, and estimating a traffic line of the target customer in the store or across the stores, according to a tendency acquired from the path information read by the path information reading unit, based on each piece of the information acquired by the information acquisition unit, and the position information and the time information calculated for the target customer.

In a sixth embodiment according to the present invention, a computer system estimating purchase behavior of a customer in a store or across stores, includes: an information acquisition unit of acquiring the article information on at least one article that the target customer purchases in the store or across the stores, layout information on each store, and shelving allocation information on each store, the article information being the identification information on the article that the target customer purchases, and position information on the target customer and time when the target customer is at each position being acquired from an apparatus installed in the store; a path information reading unit of reading at least one of previous path information on estimated travel of one or more customers in the store or across the stores, and previous path information on estimated travel of the target customer in the store or across the stores; and a traffic line estimation unit of acquiring a travel path of the target customer in the store or across the stores, based on each piece of the information acquired by the information acquisition unit, and the layout information or the shelving allocation information, estimating at least one purchase order of the at least one article that the target customer purchases, based on each piece of the information acquired by the information acquisition unit, and the acquired travel path, and estimating a traffic line of the target customer in the store, according to a tendency acquired from the path information read by the path information reading unit, based on each piece of the information acquired by the information acquisition unit.

In one of the sixth embodiment according to the present invention, the traffic line estimation unit may calculate the position information on the target customer and the time information when the target customer is at each position, based on the acquired travel path and the estimated purchase order, and estimate the traffic line of the target customer in the store, according to the tendency acquired from the path information read by the path information reading unit, based on each piece of information acquired by the information acquisition unit, and the position information and the time information calculated for the target customer.

In a seventh embodiment according to the present invention, each of a computer program and a computer program product causes a computer system to execute each step of the method of estimating purchase behavior of a customer in a store or across stores according to the present invention. A computer program according to an exemplary embodiment of the present invention can be stored in any of computer-system-readable recording media, such as one or more of a flexible disk, MO, CD-ROM, DVD, BD, hard disk device, USB-connectable memory medium, ROM, MRAM, and RAM. The computer program can be downloaded from another data processing system, e.g., computer, which is connected by a communication line, for being stored in the recording medium, or copied from another recording medium. The computer program according to the exemplary embodiment of the present invention may be compressed, or divided into multiple segments, and stored in a single or multiple recording media. It should be noted that it is a matter of course that computer program products according to embodiments of the present invention can be provided in various forms. The computer program product according to the exemplary embodiment of the present invention may involve, for instance, a storing medium that stores the computer program, and a transmission medium that transmits the computer program.

The summary of the present invention does not exclusively list all the necessary characteristics of the present invention. It should be noted that a combination or a subcombination of these configuration elements may also configure the present invention.

It is a matter of course that various modifications where hardware configuration elements of a computer used in an exemplary embodiment of the present invention are combined with multiple machines, and functions are distributed thereto may be easily assumed by those skilled in the art. These modifications are concepts involved in the spirit of the present invention as a matter of course. However, these configuration elements are only exemplified examples. Not all these configuration elements are the necessary configuration elements of the present invention.

The present invention can be implemented as hardware, software, and a combination of hardware and software. In execution through the combination of hardware and software, a typical example is execution by a computer system in which the computer program estimating the purchase behavior of the customer is installed. In such a case, the computer program is loaded into memory of the computer system and executed, thereby allowing the computer program to control the computer system and execute the processes according to the present invention. The computer program may include any language, code, or a group of instructions that can be represented through representation. Such a group of instructions enables the computer system to directly execute a specific function, or to execute the function after execution of one or both of 1. conversion into another language, code or representation, and 2. copying to another medium.

### BRIEF DESCRIPTION OF THE SEVERAL VIEWS OF THE DRAWINGS

FIG. 1 is a diagram showing an example of a hardware configuration for achieving a computer system usable in an embodiment of the present invention;

FIG. 2 shows a flowchart for performing a process of estimating purchase behavior of a customer in a store or across stores according to a first embodiment according to the present invention;

FIG. 3A shows an example of layout information in the store usable in the process of the flowchart shown in FIG. 2;

FIG. 3B shows an example of shelving allocation information in the store usable in the process of the flowchart shown in FIG. 2;

FIG. 4A shows a flowchart for performing a process of estimating purchase behavior of a customer in a store or across stores according to a second embodiment according to the present invention;

FIG. 4B is a diagram showing an example of various screens displayable together with an article purchase process operation in an apparatus associated with a target customer usable in the second embodiment according to the present invention;

FIG. 4C is a diagram showing estimation of a traffic line in consideration of path information on previous travel of a customer in the case of multiple traffic lines estimated according to the second embodiment according to the present invention;

FIG. 5 is a diagram showing an example of purchase behavior (traffic line) of a target customer estimated according to the second embodiment according to the present invention;

FIG. 6A is a flowchart for performing a process of estimating purchase behavior of a customer in a store or across stores according to a third embodiment according to the present invention;

FIG. 6B shows a different embodiment that acquires position information usable in the third embodiment according to the present invention;

FIG. 6C is a diagram showing an example of estimating a traffic line of a target customer according to the third embodiment according to the present invention;

FIG. 7 is a diagram showing an example of purchase behavior (traffic line) of a target customer estimated according to the third embodiment according to the present invention; and

FIG. 8 is a diagram showing an example of a functional block diagram of a computer that preferably has the hardware configuration according to FIG. 1 and executes an embodiment of the present invention according to the flowcharts of FIGS. 2, 4A and 6A.

Embodiments of the present invention are described according to the diagrams. Throughout the following drawings, the same symbols denote the same elements unless otherwise noted. The embodiments of the present invention are for illustrating preferred aspects of the present invention. It should be noted that there is no intention to limit the scope of the present invention to those described here.

### DETAILED DESCRIPTION

The present invention relates to a technique that estimates purchase behavior of a customer. In particular, the present invention relates to a technique that estimates a traffic line of a customer in a store or across stores.

According to the embodiment of the present invention, for instance, a manager (e.g., a store manager, a shopping center manager, a marketing company (e.g., a company performing marketing as a principal business, a company performing consulting for affiliated stores as a part of settlement business, such as a credit company, or an information selling company selling purchase histories of customers), manufactures of articles, wholesalers of articles) can accurately estimate a traffic line of a customer in a store or across stores.

Furthermore, according to the embodiment of the present invention, the manager can effectively control the traffic line of the customer and efficiently change shelving allocation or layout in a store using the estimated traffic line to improve sales. Furthermore, according to the embodiment of the present invention, the manager can optimize the traffic line for the sake of improvement in customer satisfaction rating (e.g., a layout allowing easy travel, arrangement of articles on shelves allowing the articles to be easily taken) or improvement in sales through effective space utilization in a store.

Moreover, according to the embodiment of the present invention, the manager can effectively control the traffic line of the customer, and effectively determine shelving allocation or layout in a store in corporation with one or more other sales stores (e.g., one or more other sales stores in the same mall) using the estimated traffic line across stores in order to improve sales. Furthermore, according to the embodiment of the present invention, the manager can visualize and verify change in purchase behavior after the layout of the store or across the stores or shelving allocation is modified.

The following JP05-46591A describes a customer traffic line analysis method that includes the steps of: setting a stopping places (points) for a customer on the basis of the layout of a store; setting the distance between the points adjacent to each other; solving a shortest distance problem where the shortest distance between the points and the shortest path are acquired and tabulated; identifying a stopping point on the basis of articles purchased by one customer included in register data containing POS data; setting the shortest distance between points where the one customer has stopped on the basis of the table acquired by solving the shortest distance problem; and acquiring an aisle order by solving a traveling salesman problem in order to set an aisle order of the points (claim 1).

The following JP2009-48229A describes a human behavior analysis apparatus for analyzing the characteristics of the behavior of a person in an store area on the basis of stored data in a traffic line database storing traffic line data acquired through tracking the path of the person moving in the store area and a transaction database storing transaction data by the people (claim 1).

The following Patent WO2005/111880 relates to a behavior analysis apparatus and, in particular, describes a technique of analyzing the behavior of a mobile unit in a space by position detection using a technique, such as wireless communication (paragraph [0001]).

The following Japanese Patent Publication 03-38528 describes a traffic line investigation system that can automatically investigate a travel situation, or a traffic line, of a customer in a store in a large retailer, such as a supermarket (p.1, left column, lines 15-18).

The following JP2008-052532A describes a technique where reader and writer devices provided at multiple places in a store collects customer information from an ID recording medium held by a customer, and a terminal apparatus receives information associating position information and time information with each other and customer information from the reader and writer devices, and generates traffic line information on the customer in the store (paragraph 0014).

The following JP2010-231629A describes a technique that provides a store management apparatus that can grasp a travel situation of a customer in a store using a card distributed for each customer (paragraph 0004).

The following WO2010/131629 describes a method where a customer acquires content associated with an article provided with an electronic shelf label, in a store, using a mobile processing device (paragraph 0001).

First, according to the invention described in WO2010/131629, use of a shopping support system that acquires content from an electronic shelf label (ESL) can grasp purchase behavior of a customer in an actual store; the behavior have not been acquired by a conventional POS. Accordingly, novel marketing and promotion where data in the actual store and an EC site is integrated can be achieved. In the shopping support system according to the invention described in WO2010/131629, a customer enjoys shopping using a self-owned mobile processing apparatus (e.g., a smart phone, a mobile phone, or a tablet terminal), or, for instance, a mobile processing apparatus (e.g., tablet terminal, dedicated terminal) provided at a shopping cart, a shopping basket or a shopping bag, or a shopping tool (e.g., a tool lent by a store, e.g., a store-lending tablet terminal or a dedicated scanning device (e.g., MC17 handheld retail mobile computer made by Motorola, Inc.)). However, information that can be acquired using the mobile processing apparatus is information which article is viewed and purchased at which time series or tried to be purchased. However, this information cannot identify a traffic line that represents travel in the store.

To address this problem, the present invention has an object to provide a technique that can estimate purchase behavior (e.g., traffic line or staying time) of a customer in a store or across stores, using information that can be acquired using the mobile processing apparatus, on the basis of previous purchase behavior (e.g., a traffic line or a staying time) of a target customer himself/herself, or one of more other customers.

Furthermore, the present invention has another object to provide a technique that can visualize the estimated purchase behavior of the customer. Moreover, the present invention has yet another object to visualize change in purchase behavior after the layout of a store or shelving allocation is modified, thereby allowing verification.

Furthermore, the present invention has still another object to achieve optimization of a traffic line for the sake of improvement of customer satisfaction rating (e.g., a layout allowing easy travel, arrangement of articles on shelves allowing the articles to be easily taken), or improvement in sales through effective space utilization in a store.

Next, due to rapid widespread of smart phones, indoor positioning using a Wi-Fi access point (AP), an indoor global positioning system (GPS), ultrasonic waves, visible light, infrared light, iBeacon, or sensor integration and autonomous navigation have been becoming popular. For instance, an IMES (indoor messaging system) or a GPS repeater system has been known as an indoor GPS. In particular, use of ultrasonic waves or visible light allows position information to be roughly acquired by a relatively inexpensive apparatus without a smart phone. Unfortunately, even use of these techniques cannot necessarily acquire position information on a target customer as required.

To address the problem, the present invention has an object to provide a technique that can causes an apparatus equipped for a shopping bag or basket or cart held by a shopper to acquire a position information ID provided in a store, or causes a position information acquisition apparatus installed in the store to acquire an ID unique to the equipped apparatus, and estimate purchase behavior of a target customer in the store or across the stores (e.g., a traffic line or staying time) even from the position information ID or the ID unique to the apparatus together with information on purchased articles. Furthermore, the present invention has another object to provide a technique that can estimate what order the customer has purchased articles. Moreover, the present invention has yet another object to allow purchase behavior of a target customer in an actual store that cannot be acquired through a conventional POS to be grasped, and achieve novel marketing and promotion where data on actual stores and EC sites are integrated.

Furthermore, the present invention has yet another object to provide a computer system that visualizes the purchase behavior of the customer in the store or across the stores.

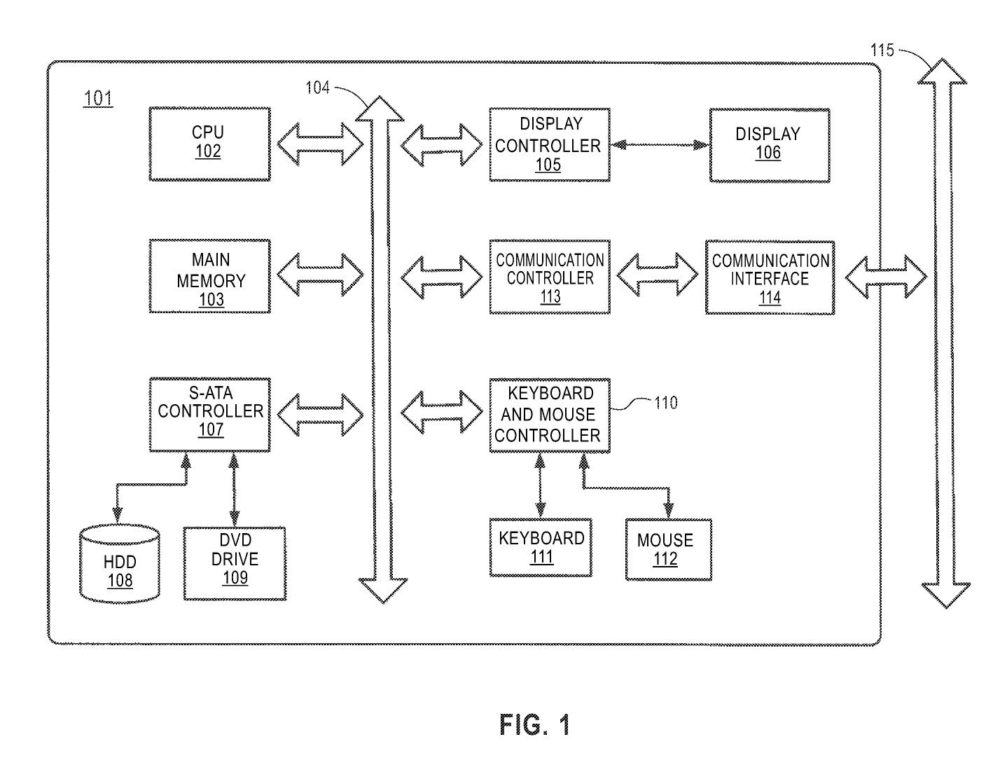

FIG. 1 is a diagram showing an example of a hardware configuration for achieving a computer system usable in an embodiment of the present invention.

A computer system (101) according to the embodiment of the present invention may include one or more computers. The computers may include, for instance, computers having different specifications of hardware, software or combination thereof. The computers may be directly connected to each other, or connected to each other via a network. The computer system (101) is not necessarily a physical computer, but may be, for instance, a virtual machine achieved on a computer installed in a data center, or a cloud environment (e.g., SoftLayer® provided by International Business Machines Corporation®).

The computer system (101) may be, for instance, a computer (e.g., a desktop computer, a notebook computer, an ultrabook, or a server computer).

The computer system (101) includes a CPU (102) and a main memory (103), which are connected to a bus (104). Preferably, the CPU (102) is based on a 32-bit or 64-bit architecture. The CPU (102) may be, for instance, Core™ series, Core™ 2 series, Atom™ series, Xeon® series, Pentium® series or Celeron® series by Intel Corporation, A series, Phenom™ series, Athlon™ series, Turion™ series or Sempron™ by AMD (Advanced Micro Devices), or Power™ series by International Business Machines Corporation.

A display (106), e.g., a liquid crystal display (LCD), may be connected to the bus (104) via a display controller (105). The liquid crystal display (LCD) may be, for instance, a touch panel display or a floating touch display. The display (106) may be used for displaying, for instance, information displayed by operation of the computer program of the seventh embodiment according to the present invention, for instance, purchase behavior of a customer in a store or across stores through an appropriate graphic interface.

A storing device (108), e.g., a hard disk or a solid state drive, may be optionally connected to the bus (104) via e.g., an SATA or IDE controller (107).

The storing device (108) and the drive (109), e.g., a CD, DVD or BD drive, may be optionally connected to the bus (104) via e.g., the SATA or IDE controller (107).

A keyboard (111) and a mouse (112) may be optionally connected to the bus (104) via a peripheral device controller (110), e.g., a keyboard and mouse controller or a USB bus.

The storing device (108) may store an operating system, Windows® OS, UNIX®, Linux® (e.g., Red Hat®, Debian®), MacOS®, and Java® execution environment such as J2EE, Java® application, Java® virtual machine (VM), a program that provides Java® just-in-time (JIT) complier, a computer program according to the embodiment of the present invention, and any other various programs, and data (e.g., article information on articles, layout information on each store, and shelving allocation information on each store, or at least one of previous path information on actual or estimated travel of one or more customers in a store or across stores, and previous path information on actual or estimated travel of a target customer in a store or across stores), in a manner loadable to the main memory (103).

The storing device (108) may be embedded in the computer system (101), connected via a cable (e.g., a USB cable) in a manner allowing the computer system (101) to access this storing device, or connected via a wired or wireless network in a manner allowing the computer system (101) to access this storing device.

The drive (109) may be used for installing a program, for instance, an operating system, or an application program (e.g., the computer program according to the seventh embodiment of the present invention), into the storing device (108) from a CD-ROM, DVD-ROM or BD-ROM, as necessary.

A communication interface (114) is in conformity with, e.g., the Ethernet® protocol. The communication interface (114) is connected to the bus (104) via the communication controller (113), performs a role of connecting the computer system (101) to a communication line (115) in a wired or wireless manner, and provides a network interface layer for the TCP/IP communication protocol of a communication function of the operating system of the computer system (101). The communication line is, for instance, a wired LAN environment in conformity with a wired LAN connection standards, or a wireless LAN environment in conformity with wireless LAN connection standards, a Wi-Fi wireless LAN environment, such as IEEE® (owned by The Institute of Electrical and Electronics Engineers, Inc.) 802.11a/b/g/n, or a mobile phone network environment (e.g., 3G or 4G (including LTE) environment).

The computer system (101) may receive data from another apparatus (e.g., another computer (e.g., server computer) or a network-attached storage) via the communication line (115) and store the data in the storing device (108).

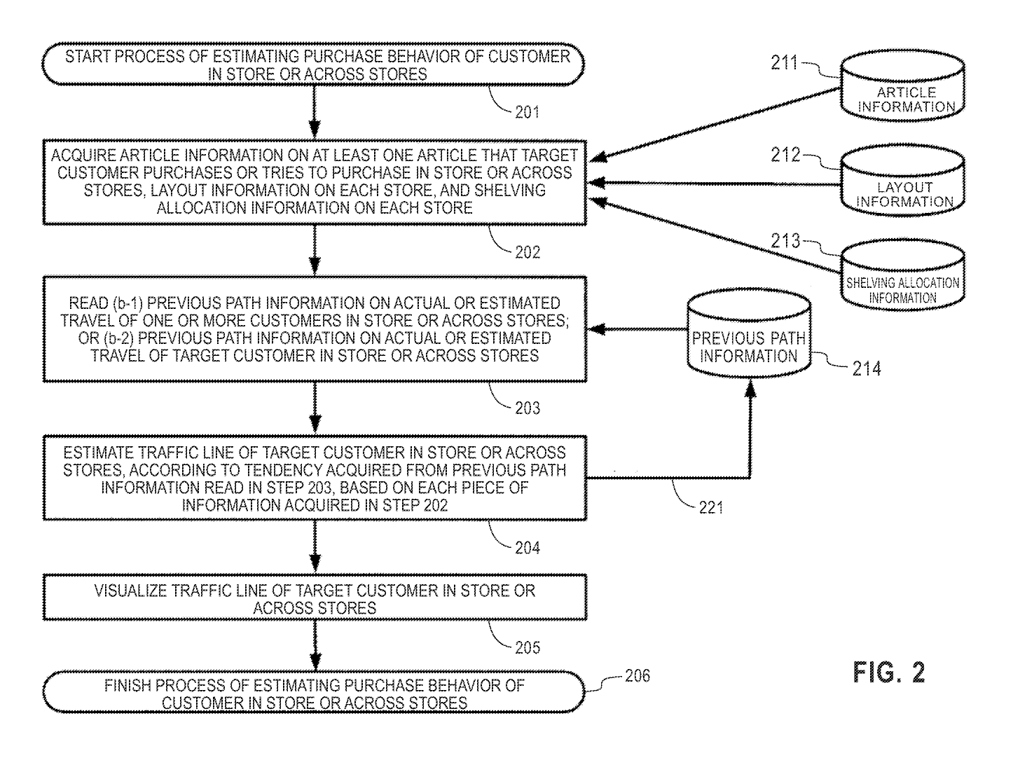

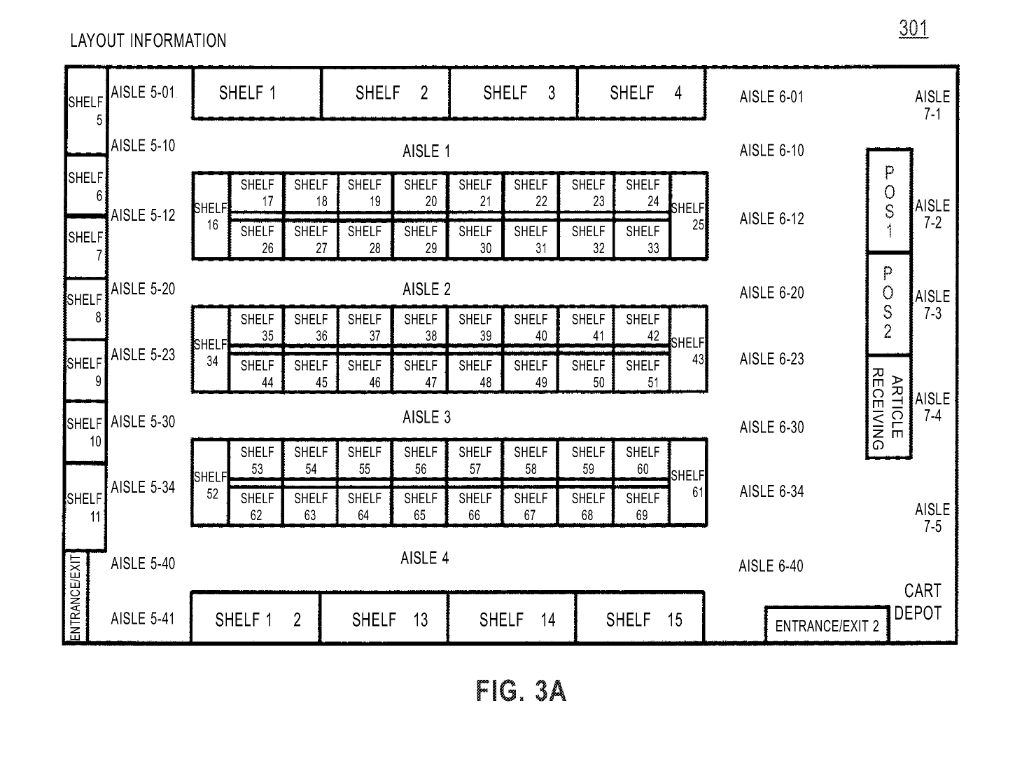

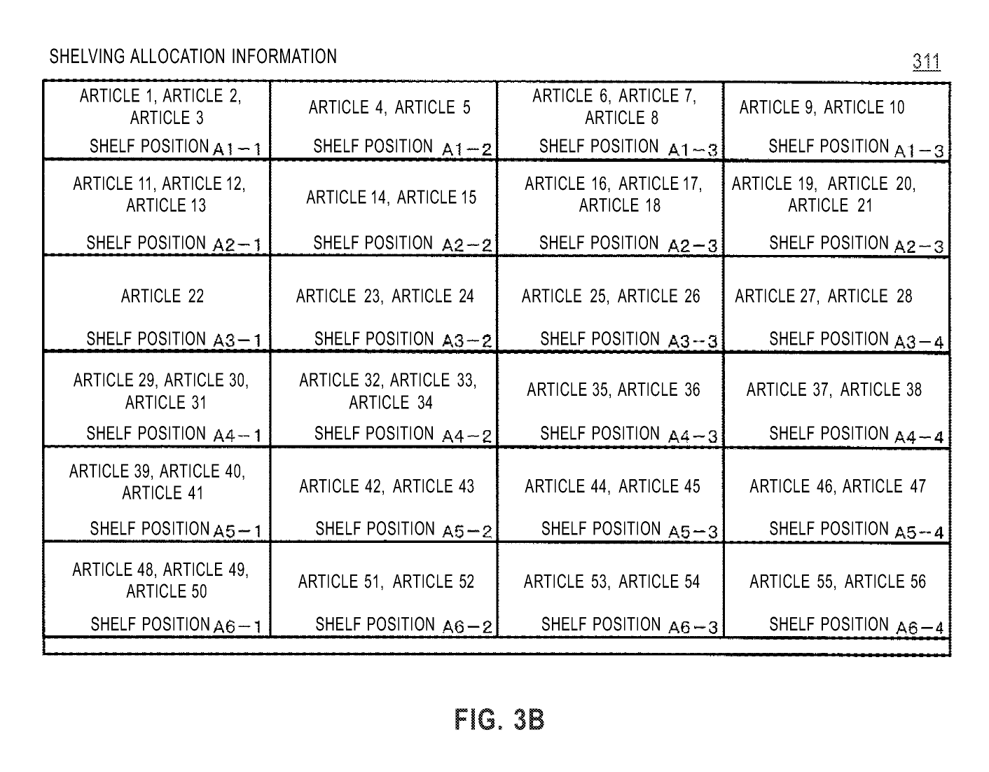

Hereinafter, a first embodiment according to the present invention is described with reference to the following FIG. 2 and the following FIGS. 3A and 3B.

### First Embodiment According to the Present Invention

FIG. 2 shows a flowchart for performing a process of estimating purchase behavior of a customer in a store or across stores according to the first embodiment of the present invention. FIGS. 3A and 3B show respective examples of layout information in the store and shelving allocation information in the store that are usable in the process of the flowchart shown in FIG. 2.

In step 201, the computer system (101) starts a process of estimating purchase behavior of a customer in a store or across stores.

In the embodiments of the present invention, “in a store” means “in one store (a single store)”. Examples of the one store include a multi-story store and one store including different buildings (e.g., a main building and an annex). In the case of one store as a building, if multiple tenants are in the store, each tenant can be regarded as a single store.

In the embodiments of the present invention, “across stores” means “across two or more stores”. Examples of the two or more stores include a type of store displaying samples, a shopping center, a shopping mall, a store of collaboration of different businesses, and a collaboratively operated store (e.g., BIQLO collaboratively operated by Bic Camera® and UNIQLO®). Examples of the two or more stores include stores distributed on one story, and stores distributed on multiple stories.

In the embodiments of the present invention, “purchase behavior” may involve a traffic line and staying time of a customer. The staying time involves staying time in a specific retail space (in front of a specific shelf, in front of a specific sensor), and staying time in a commerce facility (e.g., a store or stores); in the case without limitation, both are involved.

In step 202, the computer system (101) acquires article information on at least one article that a target customer purchases or tries to purchase in the store or across the stores, layout information on each store, and shelving allocation information on each store. For instance, “tries to purchase” may involve forms and combinations of the forms where (1) a customer “tries to purchase” an article but does not, (2) the customer “tries to purchase” the article and actually purchases the article (e.g., scans an article tag) but cancel the purchase before checkout, and (3) the customer “tries to purchase” the article and subsequently purchases the article and further checks out the article. More specifically, “tries to purchase” may involve, for instance, the case of performing a process of indicating a purchase intention by scanning an article tag without taking the article itself as in a type of store displaying samples, the case of performing a process of indicating a purchase intention by scanning an article tag in a store selling furniture because of difficulty of taking the article itself, such as large furniture.

The “target customer” in the embodiments of the present invention means a customer on which a traffic line in a store or across stores is to be estimated. The target customer may be one or more customers. For instance, the target customer may be designated by an administrator of a process of estimating purchase behavior. Alternatively, the target customer may be automatically selected by the computer system (101). The selection may be performed according to, for instance, a specific store, a specific time period, preferences of a customer on which a traffic line may be estimated (e.g., preferences on purchased articles), and characteristics of a customer on which a traffic line may be estimated (e.g., age, gender, occupation).

In the embodiments of the present invention, “article information on at least one article” may involve identification information on the article, and optionally involve time when a target customer tries to purchase the article (i.e., which may be information for acquiring identification information on the article, e.g., time when the target customer scans a bar code, or takes an image of the article itself) or time when an article is purchased (target customer presses a purchase button for a process of displaying a purchase intention for an article (which may be provided on an apparatus associated with the target customer, or displayed on a screen of the apparatus) or payment for the article is supplied at a checkout place, e.g., a POS terminal or an automatic checkout machine, or time when on-line payment is supplied). The “time” may be represented not only by hour, minute and second but also year, month and day. The “article information on at least one article” may optionally involve time when purchase of the article is canceled subsequent to the time on which the article is purchased, and optionally involve a place of the cancellation (e.g., a place estimated as a place where the canceled article is returned to the original shelf). The “article information on at least one article” may be prepared for the respective articles (i.e., for articles with different pieces of identification information). If the article information on at least one article includes the identification information on the article and the time of purchasing the article, the computer system (101) can acquire a purchase order of the articles in a time series manner. If the article information on the article includes the identification information on the article and the time of trying to purchase the article, the computer system (101) can acquire the order of scanning the bar codes of the articles for purchasing the articles in a time series manner. Furthermore, if the article information on at least one article includes the identification information on the article, time of purchasing the article, and time of trying to purchase the article (which may be time when the target customer scans the bar code of the article), the computer system (101) can acquire the order of scanning the bar codes of the articles and the purchase order of articles in a time series manner.

The computer system (101) can acquire article information on at least one article which the target customer purchases or tries to purchase in a store or across stores according to, for instance, the following “(1) article information acquisition method” or “(2) article information acquisition method”.

(1) “Article information acquisition method”: the target customer may use an apparatus associated with the target customer to scan a bar code (e.g., a one-dimensional bar code, a two-dimensional bar code or a three-dimensional bar code) attached to the article that the customer tries to purchase, or a bar code (e.g., a one-dimensional bar code, a two-dimensional bar code or a three-dimensional bar code) assigned to a shelf on which the article that the customer tries to purchase is, to acquire article information from the scanned information. Alternatively, the target customer uses a camera of the apparatus to take the article itself that the customer tries to purchase, to identify the article from the taken object, and to acquire article information on the basis of the identified article. Alternatively, the target customer may use the apparatus to receive information from a short range wireless communication function embedded in a price tag of the article (e.g., near field type wireless communication (NFC)), and acquire the article information on the basis of the received information. The apparatus may be a mobile processing apparatus owned by the target customer (e.g., a smart phone, a mobile phone, or a tablet terminal), or, for instance, a mobile processing apparatus provided for a shopping cart, a shopping basket, or a shopping bag (e.g., a tablet terminal, a dedicated terminal, a self-scanning apparatus (e.g., self-scanning by Carrefour™, or a self service kiosks)). The mobile processing apparatus owed by the target customer has an identification number for allowing the target customer to be identified (e.g., a number specific to the mobile processing apparatus (e.g., production number), a MAC address, or a specific number associated with the target customer). The identification number is not specifically limited only if the number can identify the customer through the mobile processing apparatus. Only if the customer is uniquely identified by the identification number, for instance, the mobile processing apparatuses and the customers do not necessarily have a relationship of 1:1. For instance, the same identification number may be assigned to multiple mobile processing apparatuses associated with the customer (e.g., a smart phone and a shopping basket). The mobile processing apparatus provided for the shopping cart, the shopping basket or the shopping bag has a card insertion slot into which a card (e.g., a credit card, a debit card or a cash card, or a point card, customer card or a member's card) is inserted, or a scanner or an NFC reader for reading information from the card, or a card insertion slot into which a chip for allowing the target customer to be identified (e.g., SD card) is inserted, or an NFC reader for reading information from the chip, or a function that can receive a code number for allowing the target customer to be identified, for the sake of allowing the target customer to be identified. The apparatus associated with the target customer may include means for allowing the bar code to be read, for instance, the bar code reader, the bar code scanner, or means for allowing the article to be imaged, e.g., a camera. The two-dimensional bar code may be, for instance, a QR Code®, micro QR Code®, or iQR Code®. The apparatus reads identification information on the article which the customer tries to purchase, e.g., GTIN (Global Trade Item Numbers), ISBN (International Standard Book Number), JAN (Japanese Article Number), EAN (European Article Number), or UPC (Universal Product Code), or an identification number unique to a sales store (e.g., an in-store code, ASIN (Amazon Standard Identification Numbers) by scanning the bar code, and stores the information in, e.g., a storing device. The apparatus associated with the target customer may store the time of scanning together with the identification information in the storing device. If the apparatus associated with the target customer includes a physical or on-screen button for decision for purchasing the article (i.e., which may be a purchase button for a process of indicating the purchase intention of the article), the apparatus may store, in the storing device, information on purchase decision caused by the target customer pressing the button, and optionally store the time when the button is pressed. The apparatus may store canceled identification information on the article, and the canceled time in the storing device. As described above, the apparatus associated with the target customer may acquire identification information on the article which the target customer purchases or tries to purchase, and optionally acquire the purchase time of the article. The apparatus associated with the target customer may transmit the identification information and optionally transmit the purchase time of the article to, for instance, a server (e.g., which may be the computer system (101)), e.g., at time of supplying payment for the article, through e.g., a POS terminal or an automatic checkout machine (e.g., a self-register), through on-line payment, or, e.g., through receivers provided in the store at prescribed intervals, or through receivers provided at non-dense intervals in the store. Alternatively, the apparatus associated with the target customer may transmit the identification information and optionally transmit the purchase time of the article to, e.g., the server (e.g., which may be the computer system (101)), in response to a request issued by the server. The server may store the identification information in the storing device (e.g., database) (211) that stores the article information. As described above, the computer system (101) may acquire, from the storing device (211), identification information on the purchased article (e.g., the article scanned and determined to be purchased) and the purchase time of the article (information on the purchase order of articles), identification information on the article that the customer tries to purchase (e.g., the scanned article), and the time when the customer tries to purchase the article (which may be the time when the bar code of the article is scanned), and may optionally acquire canceled identification information on the article and the canceled time. The purchase order of articles is acquired from information on purchase determination caused by the target customer pressing the button, and the time when the button is pressed.

(2) “Article information acquisition method”: the target customer supplies payment for the article using a POS terminal or an automatic checkout machine. Through the checkout, the POS terminal or the automatic checkout machine may acquire POS information, i.e., identification information on the purchased article, and the purchase time of the identification information on the purchased article (i.e., the time when the payment for the article is supplied using the POS terminal or the automatic checkout machine). The POS terminal or the automatic checkout machine may transmit the acquired identification information on the article, and optionally transmit the purchase time to, e.g., the server (e.g., which may be the computer system (101)). Alternatively, the acquired identification information on the article may be transmitted or the purchase time may optionally be transmitted to, e.g., the server (e.g., which may be the computer system (101)), in response to a request issued by the server. The server may store the identification information on the article and optionally store the purchase time in the storing device (211). As described above, the computer system (101) may acquire the identification information on the purchased article and optionally acquire the purchase time from the storing device (211). The purchase time is time when the payment for the article is supplied; accordingly, when the article for payment is supplied using the POS terminal and the automatic checkout machine, the purchase order of articles that the target customer determined to purchase on the path in the store or across the stores is unknown from the POS information. Accordingly, the purchase order of articles determined to be purchased is required to be separately estimated from another piece of information.

In the embodiments of the present invention, the “layout information on each store” may be at least one piece of arrangement information on, e.g., shelves, POS terminals, automatic checkout machines, entrances/exits, an article receiving place (article receiving counter) and a service center, and information on aisle parts, in one or more stores. For estimating purchase behavior of the customer in the store, the layout information on each store is used. For estimating purchase behavior of the customer across stores, layout information on multiple stores corresponding to the stores is used. The “layout information on each store” may be, for instance, information associating shelves with positions in the store (e.g., see shelf numbers described in FIG. 3A), information associating POS terminals with positions in the store (e.g., see POS apparatus numbers described in FIG. 3A), information associating automatic checkout machines with positions in the store, information associating entrances/exits with positions in the store (e.g., see entrance/exit numbers described in FIG. 3A), information associating an article receiving place with a position in the store (e.g., see article receiving described in FIG. 3A), information associating a service center with a position in the store, or information on aisle numbers (e.g., see aisle numbers described in FIG. 3A; e.g., “aisle 5-12” means an aisle 5 between an “aisle 1” and an “aisle 2”), shelf numbers (e.g., see shelf numbers described in FIG. 3A), connecting states of shelves (i.e., a gathered state), information about depot of carts or shopping baskets (e.g., see a cart depot described in FIG. 3A). However, the information is not limited thereto. For instance, the information associating the shelves with the positions in the store may be, for instance, identification information uniquely associated with the shelves, and positions in the store represented by two-dimensional or three-dimensional position information. The information associating the shelves with the positions in the store may be, for instance, (shelve 1, position in the store (x1, y1, z1)), (shelve 2, position in the store (x2, y2, z2)), . . . , (shelf n, position in the store (xn, yn, zn)). The computer system (101) can acquire layout information from, for instance, a storing device (212) that stores the layout information.

In the embodiments of the present invention, the “shelving allocation information on each store” is information on display of articles in one or more stores. In the case of estimating purchase behavior of a customer in the store, the information is the shelving allocation information on each store. In the case of estimating purchase behavior of a customer across stores, the information is pieces of shelving allocation information on the respective stores corresponding to the stores. The “shelving allocation information on each store” may be, for instance, information associating the articles with the positions in the store, or information associating the articles with the shelf positions. However, the information is not limited thereto. Information associating the articles with the positions in the store may be, for instance, positions in the store represented by the identification information on the articles and two-dimensional or three-dimensional position information. The information associating the articles with the positions in the store may be, for instance, (article 1, position in the store (x1, y1, z1)), (article 2, position in the store (x2, y2, z2)), . . . , (article n, position in the store (xn, yn, zn)). The information associating the articles with the shelf positions may include, for instance, identification information on the articles, and identification information uniquely associated with the shelf positions. The information associating the articles with the shelf positions may be, for instance, (article 1, shelf position (A1-1)), . . . , (article 4, shelf position (A1-2)), . . . , (article 56, shelf position (A6-4)) (see FIG. 3B). The information associating the articles with the shelf positions may be created using, for instance, planogram software (shelving allocation software). The computer system (101) may acquire the shelving allocation information from, for instance, the storing device (213) that stores the shelving allocation information. The shelving allocation information may be used to acquire the position information on the article.

In step 203, the computer system (101) reads, from a storing device (214) that stores previous path information, at least one of (b−1) previous path information on actual or estimated travel of one or more customers (a target customer or a customer different from the target customer, or combination thereof; also applicable in the following) in the store or across the stores, and (b−2) previous path information on actual or estimated travel of the target customer in the store or across the stores. The previous path information on travel of one or more customers may be information acquired by tracking positions of the one or more customers by causing the one or more customers to make purchases in the store or across the stores while carrying apparatuses that can track the respective positions of the customers. The previous path information on travel of the target customer in the store or across the stores may be information acquired by causing the target customer to make a purchase while carrying an apparatus that can track the position of the customer, and tracking the position.

In step 204, the computer system (101) estimates a traffic line of the target customer in the store or across the stores according to a tendency acquired from the previous path information read in step 203 on the basis of each piece of information acquired in step 202. Furthermore, the computer system (101) may optionally add the estimated traffic line of the target customer to the storing device (214) that stores previous path information, thereby allowing the traffic line to be utilized in estimation at the next time and thereafter (221).

The computer system (101) can acquire the position information on the target customer, and the time when the target customer is at each position according to, for instance, the following (1) “position information and time acquisition method” or (2) “position information and time acquisition method”.

(1) The “position information and time acquisition method”: the computer system (101) may calculate the position information on the target customer by looking up the identification information on the article that the target customer purchases or tries to purchase (acquired from an apparatus associated with the target customer) and, the time when the apparatus associated with the target customer reads the identification information on the article that the target customer purchases or tries to purchase (e.g., the scanning time), and the layout information or the shelving allocation information acquired in step 202 (LOOK UP). Furthermore, the computer system (101) can calculate the position information on the target customer and the time when the target customer is at each position. As to the calculation of the position information, for instance, the computer system (101) may acquire article display position information on the basis of the layout information on each store and the article shelving allocation information, and calculate that the target customer is finally at a position p at time t on the basis of the display position information and the time when the apparatus reads the identification information on the article. Furthermore, the computer system (101) may calculate time of cancellation of purchasing the article, and optionally calculate the place of cancellation (e.g., a position estimated as the position where the canceled article is returned to the original shelf).

(2) The “position information and time acquisition method”: the target customer owns the apparatus associated with the target customer. The apparatus may be, for instance, the mobile processing apparatus owned by the target customer (e.g., smart phone, mobile phone, tablet terminal, or a wearable device (e.g., a wristband, a wrist watch, or a head-mount display)), or, for instance, a mobile processing apparatus provided for a shopping cart, a shopping basket or a shopping bag (e.g., a tablet terminal, or a dedicated terminal). The apparatus may acquire the position information or position information ID from a position information transmitting device provided on e.g., the ceiling, floor, wall or shelf, or a staircase or connecting corridor in the store or across the stores, and transmit the acquired position information or position information ID and the time when the position information or position information ID is acquired, to the server, via e.g., a POS terminal or an automatic checkout machine when payment for the article is supplied, or at prescribed intervals or non-dense intervals via, e.g., the receiver installed in the store. Alternatively, the apparatus may transmit the position information on the apparatus and the time when the apparatus is at each position to the server (e.g., which may be the computer system (101)) via the receiver installed in the store at, e.g., prescribed intervals or non-dense intervals. As described above, the computer system (101) may acquire the position information on the target customer and the time when the target customer is at each position in the store. The computer system (101) may further estimate the purchase order of articles on the basis of the position information and the time when the target customer is at each position, and the identification information on the purchased article and the shelving allocation information.

In step 205, the computer system (101) visualizes the traffic line estimated in step 204, for instance, on a screen.

In step 206, the computer system (101) finishes the process of estimating the purchase behavior of the customer in the store or across the stores.

The first embodiment according to the present invention involves a second embodiment according to the present invention and a third embodiment according to the present invention, and embodiments where the second embodiment according to the present invention and the third embodiment according to the present invention are combined.

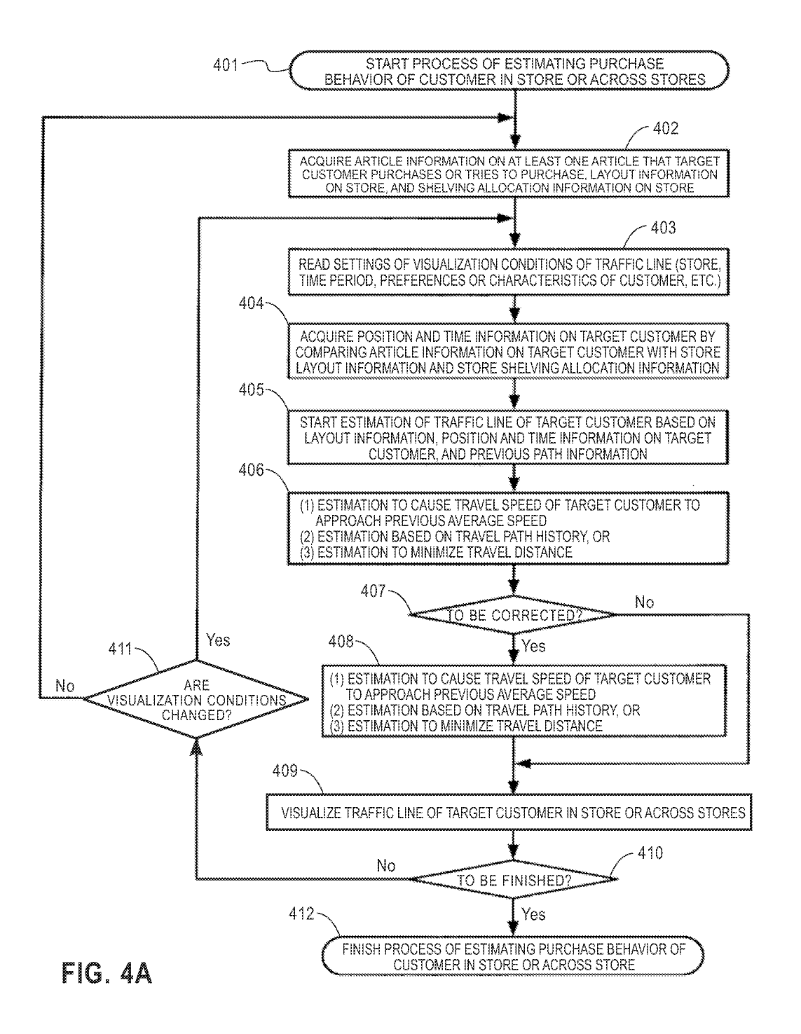

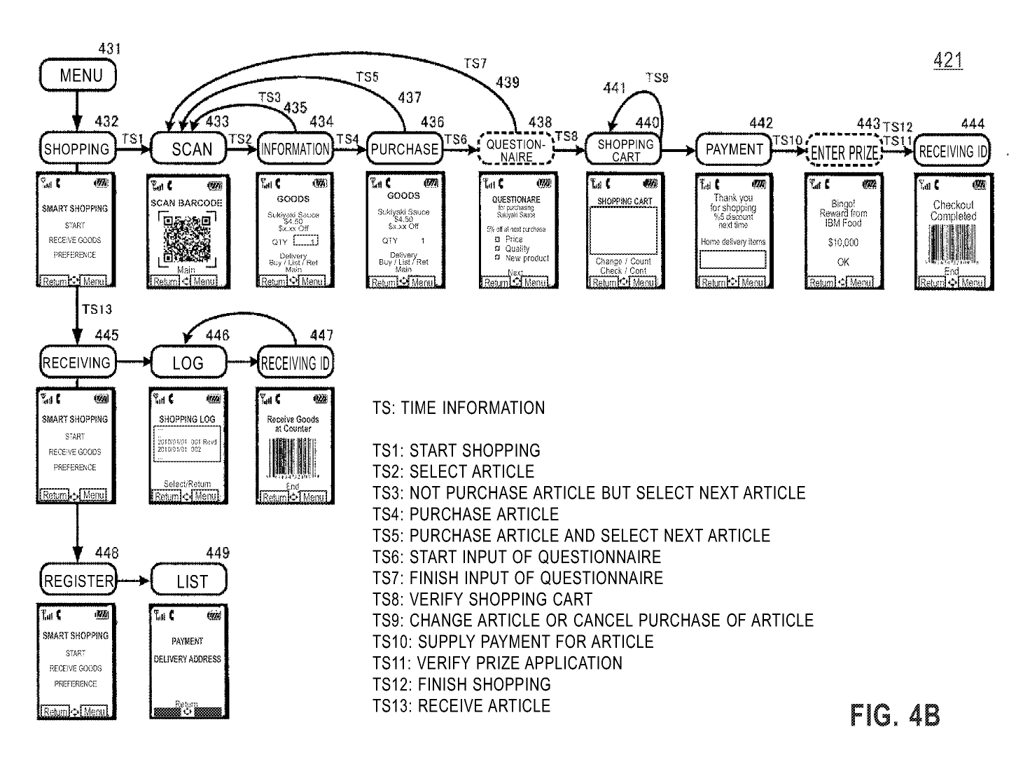

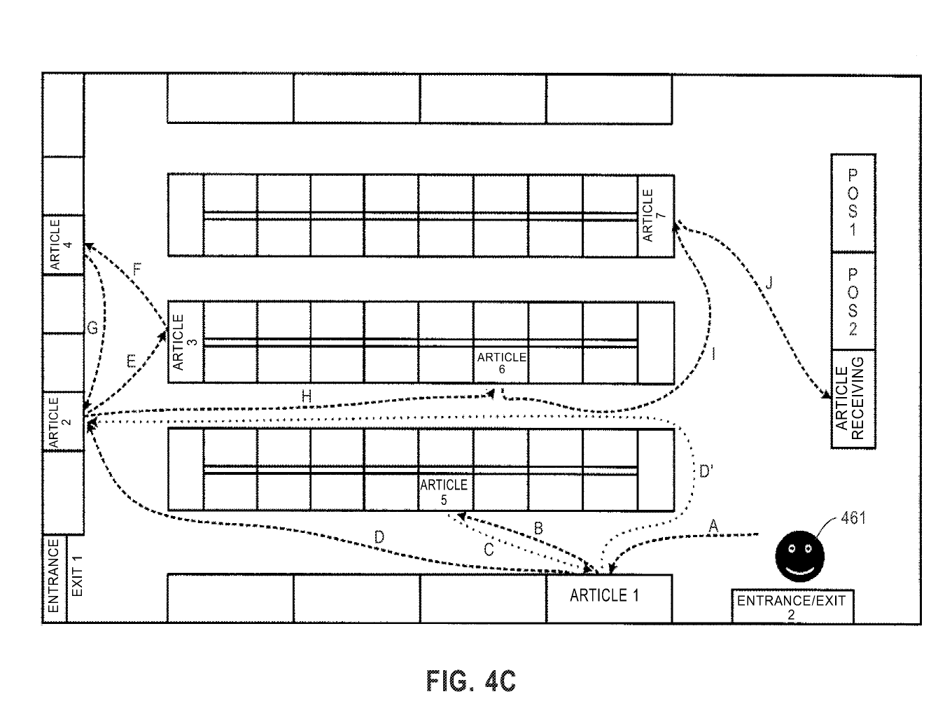

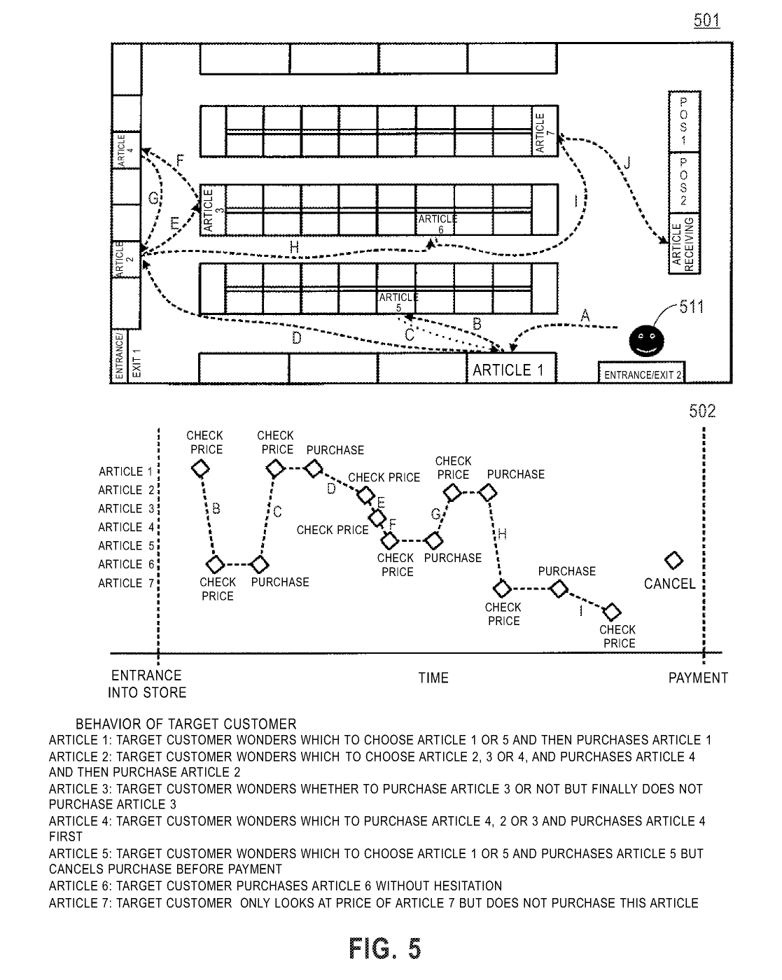

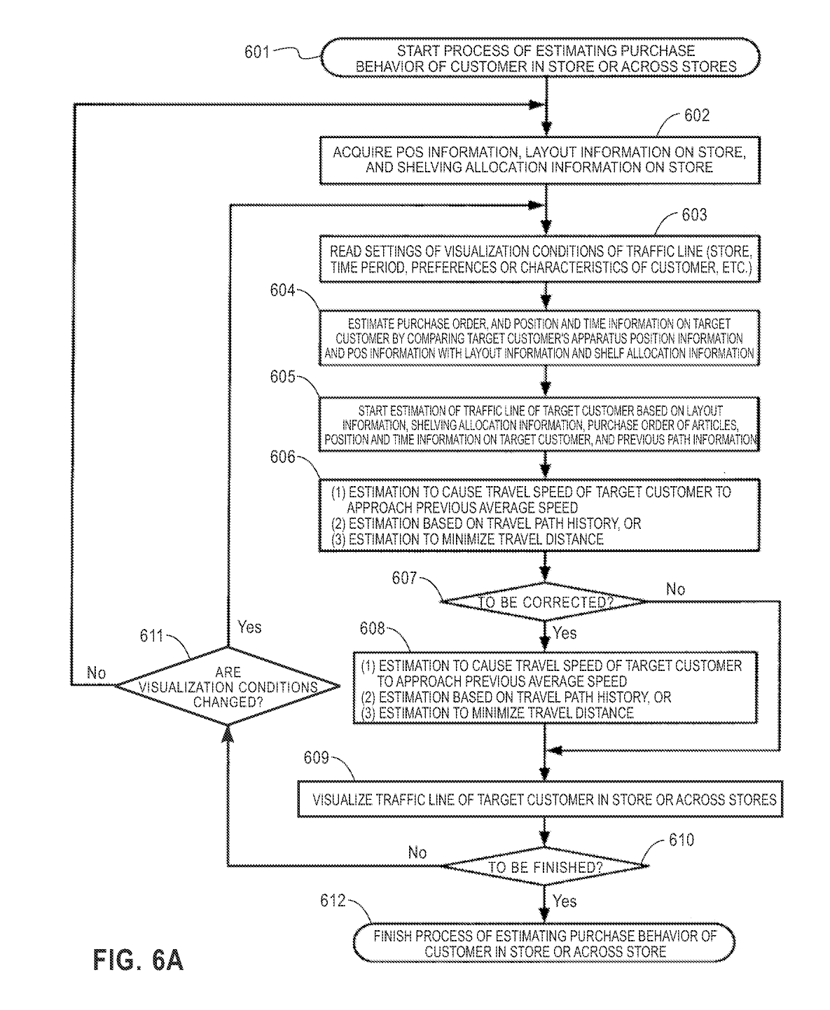

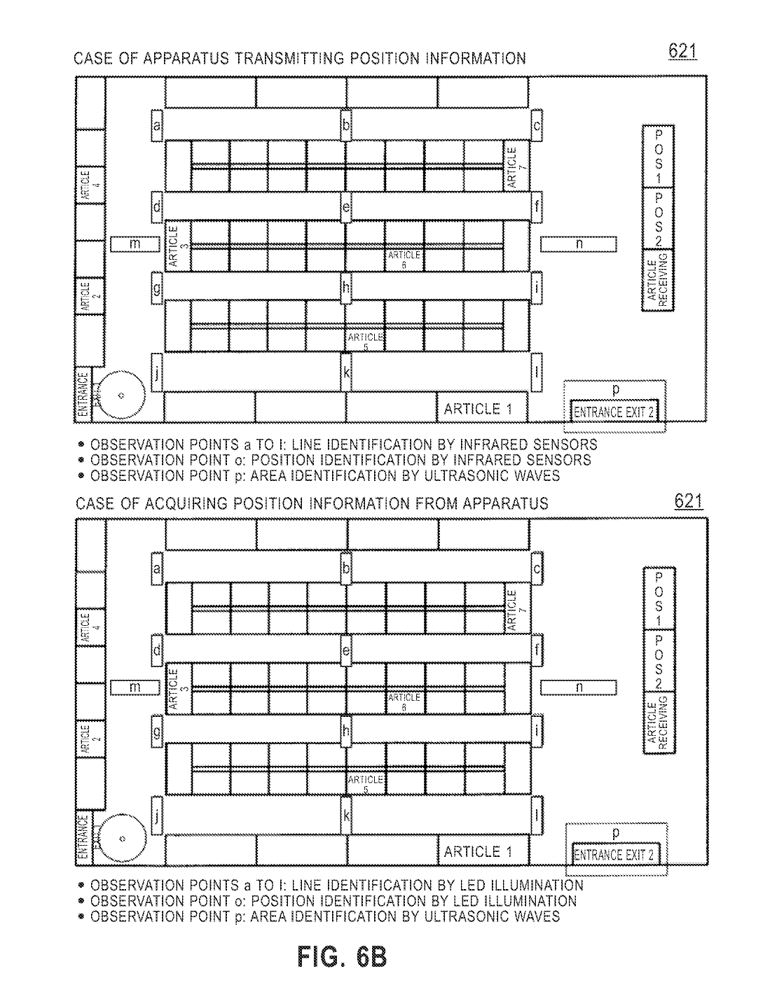

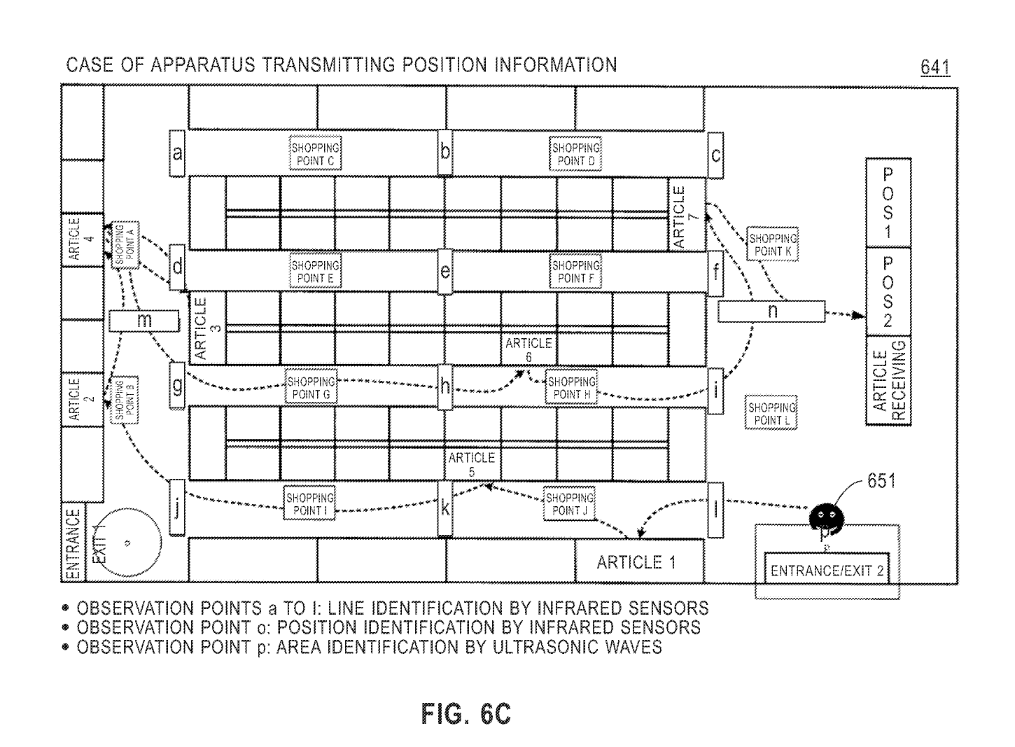

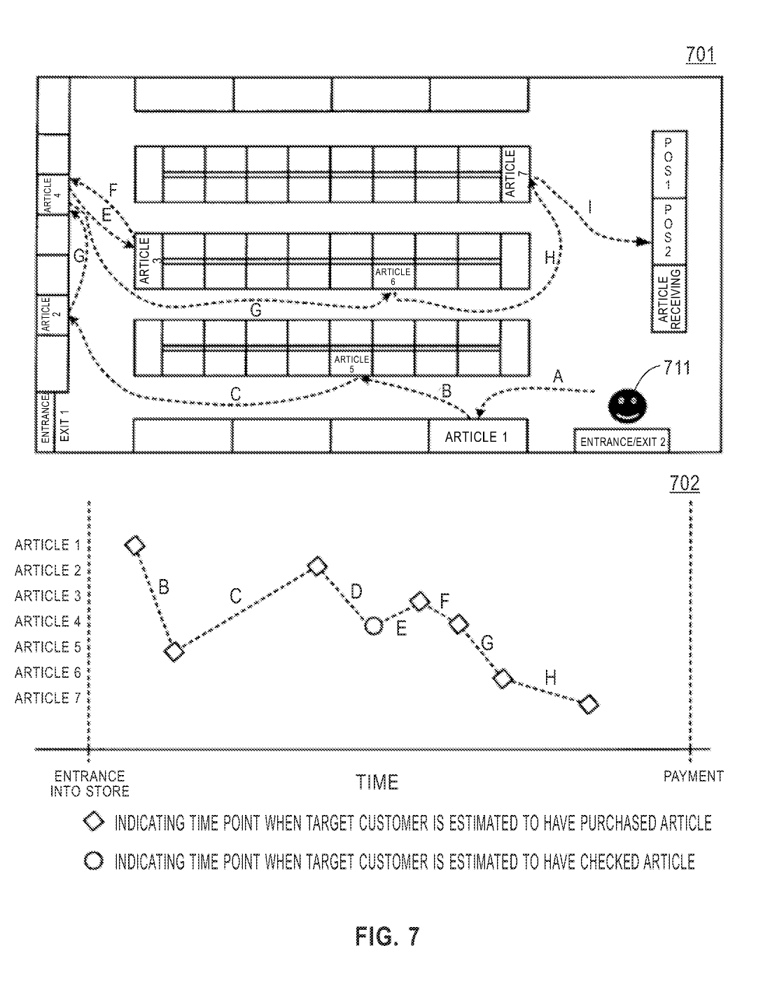

Hereinafter, the second embodiment according to the present invention is described with reference to the following FIGS. 4A to 4C and 5. Likewise, hereinafter, the third embodiment according to the present invention is described with reference to the following FIGS. 6A to 6E and 7.

### Second Embodiment According to the Present Invention

FIGS. 4A to 4C and 5 are diagrams for illustrating a process of estimating purchase behavior of a customer in the store or across the stores according to the second embodiment according to the present invention.

In the second embodiment according to the present invention, a target customer uses an apparatus associated with the target customer (hereinafter, also referred to as a first apparatus). The first apparatus includes means that can read the identification number of an article, for instance, means that can read the bar code, e.g., a bar code reader or a bar code scanner, an RFID (radio frequency identifier), a near field type wireless communication (NFC), an iBeacon™ (owned by Apple, Inc.), a wearable device (e.g., a wristband, a wrist watch, a head-mount display), or means that can read identification information on the article through a camera. The first apparatus may be a mobile processing apparatus owned by the target customer (e.g., a smart phone, a mobile phone, or a tablet terminal), or, e.g., a mobile processing apparatus provided for a shopping cart, a shopping basket or a shopping bag (e.g., a tablet terminal, a dedicated terminal).

The target customer can scan a bar code (e.g., a one-dimensional bar code, a two-dimensional bar code or a three-dimensional bar code) attached to the article that the customer tries to purchase, or a bar code (e.g., a one-dimensional bar code, a two-dimensional bar code or a three-dimensional bar code) attached to the shelf on which the article that the customer tries to purchase is placed, at or around a shelf on which the article is, using the first apparatus. Alternatively, the target customer can take the article itself that the customer tries to purchase, using the camera of the first apparatus. Alternatively, if the first apparatus is a wearable device, the target customer wears the wearable device, takes the article or touches the article tag (e.g., an electronic shelf label), thereby allowing the wearable device to acquire article information through intra-body communication using slight current. If the target customer purchases the article after the scanning or the imaging, this customer can perform a process of indicating a purchase intention (e.g., presses a purchase button on the first apparatus, or presses a purchase button displayed on the screen on the first apparatus). The process indicating a purchase intention may be, e.g., a process of putting the article in a cart on a screen.

The computer system (101) can acquire article information on at least one article that the target customer tries to purchase, through the scanning or the imaging by the first apparatus. FIG. 4B is a diagram showing an example of various screens (421) displayable together with an article purchase process operation in the first apparatus associated with the target customer usable in the second embodiment according to the present invention. Hereinafter, it is described how the target customer tries to purchase or purchases the article using the screen. Hereinafter, the case of acquiring article information on at least one article that the target customer tries to purchase through scanning by the first apparatus is described.

In step 431, the first apparatus displays an initial menu that includes a shopping menu (START), an article receiving menu (RECEIVE GOODS), and a menu for registering a personal profile (PREFERENCES) on a screen.

Steps 432 to 444 indicate steps that after selection of the shopping menu, the customer with the first apparatus scans the bar code of each article, and makes the payment for the article.

In step 432, it is assumed that the customer selects the shopping menu from the initial menu screen. The first apparatus may record the fact of the shopping start and time information on the shopping start (TS 1), in response to selection of the shopping menu. For instance, when a prescribed time elapses or, e.g., a “START” button on the screen is pressed, the first apparatus advances the processing to step 433.

In step 433, it is assumed that the customer travels in the store, and there is an article that the customer tries to purchase in the store. The customer scans the bar code attached to the article that the customer tries to purchase, or the bar code attached to the shelf on which the article that the customer tries to purchase is placed.

In step 433, the first apparatus can record selection of the article (i.e., recognition of identification information on the article that the customer tries to purchase) and time information thereon (TS2). The first apparatus may acquire article information on at least one article that the customer tries to purchase.

In step 433, the first apparatus displays the bar code that is being scanned on the screen in response to the scanning.

In step 434, the first apparatus may display information on the article associated with the identification information that is a recognition result of the bar code, e.g., the name of the article, the price (selling price, list price), quantity to be purchased, discount rate, delivery option, buttons for purchase or not, the manufacturer of the article, or the properties of the article (e.g., handling information) or precaution (e.g., which may display warning information (e.g., allergy information) to be displayed with reference to the personal profile registered in step 448). The first apparatus can acquire the information on the article on the basis of, e.g., the identification information, via online (e.g., a method through downloading information stored in a server), or via offline (e.g., a method through reading information (e.g., allergy information) embedded in the article tag, such as an electronic shelf label). If the customer does not purchase the article but, for instance, presses the “RETURN” button and then scans a bar code attached to the article that the customer tries to purchase next or a bar code attached to a shelf on which the article that the customer tries to purchase next is placed, the first apparatus advances the processing to the following step 435 and then returns the processing to the step 433. In this case, the first apparatus may record that the article is not subjected to the process of indicating a purchase intention (e.g., a process of pressing “Buy” button) but the next article is selected instead (i.e., scanning of the article that the customer tries to purchase next is started, or scanning is intended), and the time information thereon (TS3) (step 435). Furthermore, the first apparatus may acquire article information on at least one article that the customer tries to purchase but does not purchase. Meanwhile, if e.g. the customer presses the Buy button to perform the process of indicating a purchase intention for the purchased article, the first apparatus advances the processing to step 436. In this case, the first apparatus may record that the process of indicating a purchase intention is applied to the article, and the time information thereon (TS4). The first apparatus may acquire the article information on article on which a purchase intention is indicated.

In step 435, the first apparatus returns the processing to step 433 in order to display the bar code of the article that the customer tries to purchase next.

In step 436, the first apparatus may display information on the article on which a purchase intention is indicated, for instance, the name of the article, price (selling price, list price), quantity to be purchased, discount rate, and delivery option. If the customer acknowledges the purchase intention and subsequently scans the bar code attached to the article that the customer tries to purchase next or the bar code attached to the shelf on which the article that the customer tries to purchase is placed, the first apparatus advances to the processing to the following step 437 and then returns the processing to step 433. In this case, the first apparatus may record that the article is subsequently selected and scanned, and the time information thereon (TS5) (step 437). Furthermore, the first apparatus may acquire article information on at least one article that the customer tries to purchase. Meanwhile, in response to the customer indicating the purchase intention for the article and issuing an instruction for answering the questionnaire, the first apparatus advances the processing to step 438 (optional) of questionnaire processing. In this case, the first apparatus may record that input into the questionnaire is started, and the time information thereon (TS6). In the case of omitting step 438 for the questionnaire, the first apparatus can directly advance the processing from step 436 to step 440, or from step 436 to step 437 and then to step 433.

In step 437, the first apparatus advances the processing to step 433 in order to display the bar code of the article that the customer tries to purchase next.

In step 438, the first apparatus may optionally display a screen for answering a questionnaire. If input of an answer to the questionnaire is completed and subsequently the bar code attached to the article that the customer tries to purchase next or the bar code attached to the shelf on which the article that the customer tries to purchase is placed is scanned, the first apparatus returns the processing to step 433. On the other hand, in response to the customer, for instance, pressing the button (e.g., “Next” button) for displaying the list (shopping cart) of articles on which the purchase intention is indicated in order to check the list or entrance to the POS terminal or the automatic checkout machine before supplying payment for the article on which purchase intention is indicated, the first apparatus advances the processing to step 440 for verifying the correctness of the list. The first apparatus may record completion of inputting the answer to the questionnaire and the time information thereon (TS7 or TS8), in response to completion of input into the questionnaire, irrespective of whether the processing proceeds to step 439 or step 440. Furthermore, the first apparatus may acquire an input result of the answer to the questionnaire. Moreover, in response to the processing proceeding from step 433 to step 437 and then back to step 433, the first apparatus may record that the next article is subsequently selected and scanned, and the time information thereon (TS5) (step 439). Furthermore, in response to the processing proceeding to step 440, the first apparatus may record that the article list is reviewed, and the time information thereon (TS8).

In step 439, the first apparatus returns the processing to step 433 in order to display the bar code of the article that the customer tries to purchase next.

In step 440, the first apparatus displays the shopping cart on the screen to display an article list including each article on which a purchase intention is indicated. The customer may designate changing or cancelling the article on which purchase intention is indicated from the shopping cart. On the other hand, after completion of changing or cancelling the article on which purchase intention is indicated, the customer advances the processing to checkout step 442.

In step 441, in response to change or cancellation of the article on which purchase intention is indicated, the first apparatus updates the article list in the shopping cart. The first apparatus may record the change of the article on which purchase intention is indicated in the shopping cart, or the cancellation of the article on which purchase intention is indicated, and the time information thereon (TS9). The first apparatus may acquire article information on canceled articles.

In step 442, the first apparatus supplies payment for the article in the shopping cart. The payment is supplied by transmitting the article list of the shopping cart using, e.g., the POS terminal or the automatic checkout machine. The payment may be supplied through, e.g., payment of cash or payment using a credit card. Alternatively, the payment may be on-line payment where the article list of the shopping cart is transmitted to the payment server via a network (e.g., a smart phone network), and the credit card is charged. The first apparatus may record that the payment for the article is supplied, and time information thereon (TS10). Furthermore, the first apparatus may acquire article information on the purchased articles.

In step 443, the first apparatus may optionally display a prize entry screen. The first apparatus advances the processing to step 444 in response to completion of prize entry. The first apparatus may record successful verification of the prize entry, and time information thereon (TS11). Furthermore, the first apparatus may record completion of shopping, and time information thereon (TS12). If step 443 for prize entry is omitted, the first apparatus can directly advance the processing from step 442 to step 444.

In step 444, the first apparatus may display a receiving ID and optionally display a shopping completion message or a receipt on the screen. The receiving ID may be a payment ID during payment for the article, a receipt ID, or a number ID for reception of the article. The first apparatus may record completion of payment and time information thereon (TS 13). The first apparatus changes the screen back to the initial menu in response to the completion of the payment.

Steps 445 to 447 show steps where after selection on the article receiving menu, the customer uses the first apparatus to receive the article on which payment has been supplied.

In step 445, it is assumed that after completion of payment for the article, the customer selects the article receiving menu from the initial menu screen. The first apparatus advances the processing to step 446 in response to selection of the article receiving menu.

In step 446, the first apparatus displays the receiving ID list. The customer goes to the article receiving counter, and selects the article to be received at the article receiving counter with reference to the receiving ID list by, for instance, selecting a specific receiving ID. The first apparatus may change the status from paid to received and record the selected receiving ID in a log that stores the receiving IDs.

In step 447, the first apparatus displays the receiving ID pertaining to an unreceived article stored in the log, or the bar code corresponding to the receiving ID pertaining to the unreceived article on the display. The customer may present the receiving ID pertaining to the unreceived article to the article receiving counter, and receive an article associated with the receiving ID pertaining to the unreceived article. A store staff at the article receiving counter gives the customer the article corresponding to the receiving ID pertaining to the unreceived article or a pick-up pack that stores the article, or scans the bar code corresponding to the receiving ID pertaining to the unreceived article using a scanner at the article receiving counter and passes the article corresponding to the receiving ID pertaining to the unreceived article or the pick-up pack that stores this article to the customer. The first apparatus changes the screen back to the initial menu in response to completion of reception of the article. Alternatively, the first apparatus may display, on the screen, the receiving ID list that allows another receiving ID to be designated for the unreceived article in order to receive another unreceived purchased article (step 446).

Steps 448 to 449 show processes where a menu for registering the personal profile is selected and subsequently the customer uses the first apparatus to register and to list the personal profile.

In step 448, the first apparatus may register the personal profile (e.g., the address, name, gender, age, allergy information, and other shopping characteristics information). The first apparatus may use the registered information to personalize the information on the article displayed in step 434 and present the information. For instance, the customer registers items that the customer personally takes care (e.g., allergens and contraindicated drugs) in the first apparatus, or registers personal settings in the storing device (108) of the computer system (101) or another storing device accessible from the computer system (101) (e.g., a server computer or a network-attached storage) through operation of a menu for registering the personal profile, thereby allowing the first apparatus to present, to the customer, warning or information for calling for attention, or one or more alternative articles that do not include the allergens or the contraindicated drugs when the customer scans the one or more articles using the first apparatus.

In step 449, the first apparatus may list and edit the personal profile registered in step 448. The first apparatus changes the screen back to the initial menu in response to an instruction of finishing displaying the list.

As described above, the second embodiment according to the present invention can acquire time when the target customer tries to purchase articles and time when purchase intention for articles is indicated, in a time series manner. Those skilled in the art can arbitrarily change the display on the screen, the transition order on the screen, or the procedures for purchasing the articles using display on the screen.

FIG. 4A shows a flowchart for performing a process of estimating purchase behavior of the customer in the store or across the stores according to the second embodiment according to the present invention.

In step 401, the computer system (101) starts the process of estimating purchase behavior of the customer in the store or across the stores.

In step 402, the computer system (101) acquires article information on at least one article that the target customer purchases or tries to purchase in the store or across the stores, the layout information on each store, and the shelving allocation information on each store. The computer system (101) may acquire the article information from, e.g., the storing device (211) that stores the article information. The computer system (101) may acquire the layout information on each store from, e.g., the storing device (212) that stores the layout information. The computer system (101) acquires the shelving allocation information on each store from, e.g., the storing device (213) that stores the shelving allocation information.

The computer system (101) may acquire the article information on at least one article according to the (1) “article information acquisition method” described in step 202 in FIG. 2. The article information on at least one article may be, for instance, information acquired in response to operation or input on the screen of the first apparatus associated with the target customer (e.g., the screen shown in FIG. 4B).

In step 403, the computer system (101) reads settings of a visualization conditions of a traffic line that may be designated by, e.g., an administrator of the process of estimating purchase behavior. The visualization conditions of the traffic line are conditions for selecting the target customer. For instance, the conditions may be a specific store, a specific time period, the preferences of a customer on which a traffic line may be estimated (e.g., preferences for purchased articles), the characteristics of a customer on which a traffic line may be estimated (e.g., age, gender, and occupation). The computer system (101) can identify one or more target customers according to the settings of the visualization conditions.

In step 404, the computer system (101) acquires pieces of position information on the target customer in the store or across the stores, and time corresponding to each position, by comparing the article information pertaining to the target customer with the layout information on each store and the shelving allocation information on each store. The computer system (101) may acquire multiple positions of the target customer, and time when the target customer is at each position, according to the foregoing (1) “position information and time acquisition method” described in step 204 in FIG. 2.

In step 405, the computer system (101) starts estimation of the traffic line of the target customer (the traffic line in the store, the traffic line across stores, or combination thereof) on the basis of the layout information on each store, the multiple positions of the target customer and the time corresponding to each position acquired in step 404, and the previous path information (corresponding to the previous path information read in step 203 in FIG. 2).

In step 406, the computer system (101) estimates the traffic line by the following (1) “estimation process method (average speed method)”, (2) “estimation process method (travel path history method)”, or (3) “estimation process method (travel distance minimizing method)”. The (1) “estimation process method (average speed method)” is a method of estimating the travel path from the travel time in the store or across the stores. The (2) “estimation process method (travel path history method)” is a method of estimating the travel path from the travel path histories of previous customers or previous target customers. The (3) “estimation process method (travel distance minimizing method)” is a method of estimating the travel path from the travel distance in the store or across the stores.

(1) The “estimation process method (average speed method)”: the computer system (101) estimates a roughly estimated path from entrance to exit into and from the store (e.g., from the entrance to the exit) (including multiple checkouts), or a roughly estimated path from entrance to exit across stores (including multiple checkouts in one store, or checkouts at each store) (hereinafter, referred to as an estimated path), by connecting the multiple positions in a time series manner so as to make the average speed constant as much as possible on the basis of the multiple positions acquired in step 404 and the time when the customer is at each position. The computer system (101) may estimate the estimated path so as to approach a previous average travel speed. The computer system (101) may use, as the previous average travel speed, an average travel speed acquired from previous path information that the target customer traveled in the store or across the stores, or previous path information on estimated travel thereof, or previous path information that one or more customers traveled in the store or across the stores, or previous path information on estimated travel thereof.

The computer system (101) may define, as a coefficient of the travel speed, whether a purchase is made or not at the retail space (the number of purchased articles and the amount of money of articles, or the properties of the article (e.g., the weight and size of the article, allergy information, or categories (e.g., food, clothes, furniture))), on each retail space (path) to be passed. This is because it is assumed that, when the amount of money of articles that the customer tries to purchase or purchases is large, the staying time at the retail space increases. Defining the coefficient of the travel speed improves the accuracy of estimating the path. In the estimation, it can be considered that defining the coefficient of the travel speed reduces the speed a little at a retail space where deliberate consideration is required, e.g., a jewelry retail space, a furniture retail space or a large consumer electrical appliance retail space, or greatly reduces the passing speed during purchase of articles at such a retail space.

A technique for, e.g., a car navigation system may be used as a technique of making the average speed constant. For the technique for the car navigation system, see e.g., the foregoing JP2004-198165A.

(2) The “estimation process method (travel path history method)”: the computer system (101) acquires the following Data A and B, as inputs. Data A: a set of articles that the customer purchases (in this set, the articles are arranged time-sequentially in an order according to which the customer tries to purchase); and Data B: path information according to which some customers providing the histories in Data A have actually passed (which corresponds to Data A).

The data B is acquired as follows. That is, one or more customers (target customer or one or more customers different from the target customer or a combination thereof) do shopping in the store or across the stores while carrying apparatuses capable of tracking the positions of the respective customers, and the positions are tracked, thus acquiring the data. Only the paths of a small number of customers are sufficient for the method of acquiring the data B. Preparing data on many customers would increase the cost for acquiring the data.

The computer system (101) acquires an output corresponding to the input according to the following procedures 1 to 5.

Procedure 1: computer system (101) divides the path information on data B into sets of (1) a partial path from an entrance or a cart or basket depot in the store to a position where the customer tries to purchase a certain article (first article) first, (2) one or more partial paths from a position where the customer tries to purchase a certain article to a position where the customer tries to purchase another article next (e.g., from the position where the customer tries to purchase the first article to a position where the customer tries to purchase a second article, from the position where the customer tries to purchase the second article to a position where the customer tries to purchase a third article, from a position where the customer tries to purchase the n−2^{th} article to a position where the customer tries to purchase n−1^{th} article), and (3) a partial path from a position where the customer tries to purchase a certain article lastly (e.g., the second article, . . . , or the n^{th} article) to the checkout place in the store, or the exit or the cart or basket depot in the store, for example. The computer system (101) acquires path information on the sets of partial paths divided from the data B.

Procedure 2: The computer system (101) attaches labels to the respective aisles in the store according to a predetermined classification. Alternatively, the computer system (101) acquires information on aisles labeled according to the predetermined classification. For instance, the labels are attached as follows: A forward direction of a main aisle on the periphery (type 1), A reverse direction of the main aisle on the periphery (type 2), An aisle in front of POS terminal (type 3), and Other aisles (type 4).

Procedure 3: the computer system (101) calculates a weight vector w for the cost so as to allow the set of partial paths in the procedure 1 to be described most appropriately. The computer system (101) calculates, for instance, the cost of the partial path from a position where the customer tries to purchase a certain article to a position where the customer tries to purchase another article next, by the following expression: C=Σ_n w_n×(distance where the customer has walked along type n aisle).

In the case of assuming that a path at a cost C is selected at a probability proportional to exp(−C), the weight of maximizing the likelihood of a path where the customer actually passes may be calculated by solving a convex optimization problem. For instance, the method described in Brian D. Ziebart et. al. may be adopted as a method of calculation by solving the convex optimization problem.

Here, C is the path cost and, in particular, the path cost of one shopping trip of the target customer. Σ_n is the total sum of all n. For instance, Σ_n is as follows: 4, Σ, i=1, w_n is a weight for a cost in the case of passing along type n aisle over a unit distance. w is a weight vector for the cost. For instance, w is as follows: w_{—}1, w_{—}2, w_{—}3, w_{—}4.

In the procedure 3, in order to determine how strong the tendencies of passing through the respective aisles labeled in the procedure 2 are, the computer system (101) performs quantitative estimation on the basis of the set of paths in the store where one or more customers have actually passed, thereby acquiring the weight w.

Procedure 4: the computer system (101) solves a shortest path problem so as to minimize the cost, using the weight vector w acquired in the procedure 3, thereby estimating the path where the customer has actually passed.

In the procedure 4, for instance, in the case where the same articles X are arranged in different places in the same store and the target customer tries to purchase in an order of an article A, an article X and an article B, the computer system (101) may estimate that the customer tries to purchase the article X at a place that minimizes the sum of the cost of a path from a place where the customer tries to purchase the article A to a place where the customer tries to purchase the article X and the cost of a path from a place where the customer tries to purchase the article X to a place where the customer tries to purchase the article B.

Procedure 5: the computer system (101) connects the partial paths acquired in the procedure 4 to make, for instance, one path from the entrance or the cart or basket depot in the store to the checkout place in the store, or the exit or the cart or basket depot in the store.

(3) The “estimation process method (travel distance minimizing method)”: the computer system (101) connects time-sequentially the multiple positions at the shortest distance on the basis of the multiple positions acquired in step 404 and the time when the customer is at the respective positions, thereby estimating a roughly estimated path (including multiple checkouts) from entrance to checkout or from entrance to exit at the store (e.g., from the entrance to the exit), or a roughly estimated path from entrance to checkout or entrance to exit across multiple stores (multiple checkouts in one store or a checkout in each store).

In step 407, the computer system (101) determines whether to modify the path estimated in step 406. In step 406, the path that can most appropriately describe the set of partial paths in the procedure 1 is selected. However, there is a case where a gap occurs in the description even by all means. If the gap exceeds a certain threshold, the computer system (101) is required to recalculate the path including measurement error. In the case of requiring such recalculation, the computer system (101) may determine that the estimated path is to be modified. The computer system (101) uses, e.g., a deviation from an average of evaluation values of tendency as the certain threshold, and may set, for instance, 1σ or 2σ concerning the standard deviation. In response to modifying the path, the processing proceeds to step 408. On the contrary, in response to not modifying the path, the processing proceeds to step 409.

In step 408, if the computer system (101) modifies the path estimated in step 406, this system may modify the estimated path using the estimation process method different from the estimation process method used in step 406.

If the estimation process method used in step 406 is the (1) “estimation process method (average speed method)”, the computer system (101) may use, in step 408, the (2) “estimation process method (travel path history method)”, or the (3) “estimation process method (travel distance minimizing method)”.

If the estimation process method used in step 406 is the (2) “estimation process method (travel path history method)”, the computer system (101) may use, in step 408, the (1) “estimation process method (average speed method)”, or the (3) “estimation process method (travel distance minimizing method)”.

If the estimation process method used in step 406 is the (3) “estimation process method (travel distance minimizing method)”, the computer system (101) uses, in step 408, the (1) “estimation process method (average speed method)”, or the (2) “estimation process method (travel path history method)”.

In step 406, the path that can most appropriately describe the set of partial paths of the procedure 1 has been described. However, the traffic line may be estimated optionally according to one or more conditions (weighting) shown in the following (a) to (d):

(a) in a case where pieces of path information representing different travel paths having high similarity are extracted, the previous path information on the target customer is more preferentially selected than the previous path information on the other customers;

(b) in a case where pieces of path information representing different travel paths having high similarity are extracted, the previous path information on one or more customers with one or more articles belonging to the same shopping category or with the same or similar purchased article(s) is preferentially selected;

(c) in a case where pieces of path information representing different travel paths having high similarity are extracted, the previous path information on one or more customers with the same or similar characteristics of customers, e.g., the age, gender, or travel speed of the target customer is preferentially selected;

(d) in a case where pieces of path information having high similarity are not extracted, a travel path with a shopping point of the acquired travel path reduced at least by one is compared with the previous path information, and path information having high similarity is preferentially selected. The preferential selection may be performed by, for instance, attaching a preferential tag to the preferentially selected path information.

In step 406, the path that can most appropriately describe the set of partial paths in the procedure 1 has been estimated. However, a gap occurs in the description of the purchase behavior of the target customer based on the estimated path even by all means, the computer system (101) may optionally modify the layout information on each store or shelving allocation information on each store or a combination thereof. For instance, the case of difficulty to estimate the traffic line on a certain article at a small probability may be a case where the specific article is placed at a place different from that of the shelving allocation information, a case where the customer returns the specific article to a position different from the original position for cancellation, a case where the article tag associated with the specific article is the article tag of another article, or a case where an employee displays the specific article at a position different from the position where the article should be displayed. For instance, if the specific article is placed only at a place different from that of the shelving allocation information, all the traffic lines estimated on the customer having purchased the specific article indicate abnormality. Alternatively, if the specific article is placed also at a place different from that of the shelving allocation information, the traffic line (i.e., the traffic lines of some customers) estimated on a customer with the article placed on the different position indicates abnormality. In such cases, in consideration of the shelving allocation information on each store, the computer system (101) can assume that or change such that the position information on the specific article indicates another appropriate position, or register the information so as to indicate multiple positions, thereby allowing the abnormal traffic line to be modified to be a normal traffic line.

In step 409, the computer system (101) visualizes the traffic line estimated in step 406, or the traffic line adjusted in step 408 on, e.g., the screen.

In step 410, the computer system (101) determines whether to finish the process of estimating purchase behavior or not. The computer system (101) advances the processing to step 411 according to the determination of not finishing the process. On the other hand, the computer system (101) advances the processing to step 412 according to the determination of finishing the process.

In step 411, the computer system (101) determines whether to change the visualization conditions or not. The computer system (101) returns the processing to step 403 according to change of the visualization conditions. The computer system (101) may return the processing to step 403, and identify one or more target customers according to the changed visualization conditions. On the other hand, the computer system (101) returns the processing to step 402 according to the visualization conditions being unchanged, can change the layout information, the shelving allocation information, or the combination thereof, and perform a process of simulating the traffic line of the customer in the case of the change (i.e., steps 403 to 409).

In step 412, the computer system (101) finishes the process of estimating purchase behavior of the customer in the store or across the stores.

FIG. 4C is a diagram showing estimated traffic line in consideration of the path information on previous travel of the customer in the case of multiple traffic lines estimated according to the second embodiment according to the present invention.

A screen (451) is a diagram of estimation of a traffic line according to second embodiment according to the present invention in the case where a target customer (461) enjoys shopping (one shopping trip) in a certain store. The computer system (101) estimates that the target customer (461) enters the store from an entrance/exit 2, travels in the order of the shelf with the article 1, the shelf with the article 5, the shelf with the article 1, the shelf with the article 2, the shelf with the article 3, the shelf with the article 4, the shelf with the article 2, the shelf with the article 6, and the shelf with the article 7 and then travels to an article receiving place. That is, the estimated traffic line of the target customer is A→B→C→D or D′→E→F→G→H→I→J.

Simply according to estimation by the travel distance minimizing method, travel from a position where the article 1 that the customer tries to purchase or purchases to a position where the article 2 that the customer tries to purchase or purchases next is travel in the left direction as indicated by a path denoted by D. However, in the case where travel from the position where the article 1 is to the position where the article 2 is takes time, it is assumed that most of the previous travel paths of one or more customers pass to the right through a path denoted by D′. There is then a possibility that the target customer likewise passes through the path denoted by D′ instead of the path denoted by D.

Thus, use of the estimation process method (2) “travel path history method” used in step 406 allows estimation of a travel path more similar to an actual path of the customer.

On the screen (451), the case of one shopping trip in the single store having the layout shown on the screen (451) has been described as an example.

In the case of the single store, the embodiment of shopping is not limited to the above example. Alternatively, for instance, the following various embodiments may be assumed:

(1) there is a case where even in a single store, payment for articles should be supplied on each floor where purchases are made; (2) there is a case where even with a certain size of the store, several tens of POS terminals are arranged side by side or arranged longitudinally and latitudinally; (3) there is a case where the customer does not stop at the POS terminal but can supply payment by online card settlement at any place instead; (4) there is a case where multiple shopping trips are made because of an article that the customer forgot to purchase after payment; and (5) there is a case where, if the store has a form of a single store but multiple tenants are on the same floor, payment for the articles should be supplied on a tenant-by-tenant basis. Even with any of such forms in the single store, the traffic line of the target customer in the single store can be estimated by the second embodiment according to the present invention.

In the case where the customer purchases articles across stores, i.e., multiple stores, for instance, the following various embodiments may be assumed: (6) there is a case where payment for articles should be supplied on a store-by-store basis; (7) there is a case where even if articles are purchased across multiple stores, payment for the purchased articles can be integrally supplied at one time at conventional checkout place; and (8) there is a case where even if articles are purchased across multiple stores, payment for the articles in all stores can be integrally supplied at one time at any place. In any of such embodiments across stores, the traffic line of the target customer in the single store can be estimated by the second embodiment according to the present invention.

FIG. 5 is a diagram showing an example of purchase behavior (traffic line) of the target customer estimated according to the second embodiment of the present invention.

A screen (501) is a diagram showing estimation of the traffic line in the case where a target customer (511) enjoys shopping in a certain store according to the second embodiment of the present invention. The computer system (101) estimates that the target customer (511) enters the store from the entrance/exit 2, travels in an order of the shelf with the article 1, the shelf with the article 5, the shelf with the article 1, the shelf with the article 2, the shelf with the article 3, the shelf with the article 4, the shelf with the article 2, the shelf with the article 6, and the shelf with the article 7, and then travels to the article receiving place. That is, the estimated traffic line of the target customer is A→B→C→D→E→F→G→H→I→J. The article receiving place is, for instance, a place for receiving articles designated for takeaway if the customer supplies payment for the articles that the customer purchases through online settlement on a terminal associated with the customer. In the case of articles not designated for takeaway (i.e., in the case of articles designated for delivery), the articles designated for delivery is delivered to a place designated by the customer (e.g., home of the customer).

It is assumed that purchase behavior of the target customer (511) is as shown in the diagram (502) on the basis of the estimated traffic line of the target customer (511).

(1) The target customer (511) enters the store from the entrance/exit 2 and subsequently travels to the shelf with the article 1 (path A). In order to indicate that entrance into the shop at the entrance/exit 2, for instance, the target customer may record entrance into the store, by causing a terminal associated with the target customer to be scanned at an entrance check point (e.g., a kiosk terminal for recording entrance) to transmit entrance information, or causing the terminal associated with the target customer to read check point information on an apparatus that is installed at the entrance check point but does not has a communication function or on paper, or activating an application on the terminal associated with the target customer. Alternatively, in order to indicate entrance into the shop, for instance, the target customer may allow the power of an apparatus to be turned on through, e.g., operation of a latch attached to the shopping cart or the shopping basket to automatically turn on the power of the apparatus, in response to, e.g., turning on a power switch of the apparatus attached to the shopping cart or the shopping basket, or pressing a button for start use, or pulling out the shopping cart or the shopping basket from a shopping cart depot or a shopping basket depot.

(2) The target customer (511) checks the price of the article 1 (i.e., scans the bar code by the article 1) and then travels to a shelf with the article 5 (path B).

(3) The target customer (511) checks the price of the article 5 and then purchases the article 5. Subsequently, the target customer (511) travels to the shelf with the article 1 (path C).

(4) The target customer (511) rechecks the price of the article 1 and then purchases the article 1. Subsequently, the target customer (511) travels to the shelf with the article 2 (path D).

(5) The target customer (511) checks the price of the article 2 and then travels to the shelf with the article 3 (path E).

(6) The target customer (511) checks the price of the article 3 and then travels to the shelf with the article 4 (path F).

(7) The target customer (511) checks the price of the article 4 and then purchases the article 4. Subsequently, the target customer (511) travels to the shelf with the article 2 (path G).

(8) The target customer (511) rechecks the price of the article 2 and then purchases the article 2. Subsequently, the target customer (511) travels to the shelf with the article 6 (path H).

(9) The target customer (511) checks the price of the article 6 and then purchases the article 6. Subsequently, the target customer (511) travels to the shelf with the article 7 (path I).

(10) The target customer (511) checks the price of the article 7 and then travels to the article receiving place (path J).

(11) The target customer (511) cancels the purchase of the article 5 during travel along a path J.

Through use of the traffic line estimated according to the second embodiment of the present invention, for instance, a manager (e.g., a store manager, a shopping center manager, a marketing company, manufactures of articles, wholesalers of articles) can correctly grasp in-store behavior of the customer in the store or across the stores. Accordingly, the manager can efficiently provide the shelving allocation and layout, effectively control the traffic lines of customers in the store or across the stores, thereby allowing sales to be improved.

In the estimation of the traffic line according to the second embodiment of the present invention, the path that can most appropriately describe the set of partial paths is estimated. As described above, if description through use of the estimated traffic line causes a gap, the computer system (101) can modify the layout information on each store or the shelving allocation information on each store.

Furthermore, if description through use of the traffic line estimated according to the second embodiment of the present invention causes a gap, as to a fake of the article (e.g., an article that is not on sale is wrongly displayed on a shelf) and the wrongly arranged article (e.g., arrangement in a wrong retail space (e.g., different shelf) irrespective whether intentionally arranged or not), the fake of the article can be removed and the wrongly arranged article can be moved to a correct place.

### Third Embodiment According to the Present Invention

FIGS. 6A to 6C and 7 are diagrams for illustrating a process of estimating purchase behavior of the customer in the store or across the stores according to a third embodiment according to the present invention.

In the third embodiment according to the present invention, the target customer uses an apparatus associated with the target customer (hereinafter, also referred to as a second apparatus). The second apparatus includes a function that can identify that the target customer passes a certain place in the store or across the stores. The second apparatus may be a mobile processing apparatus owned by the target customer (e.g., a smart phone, a mobile phone, or a tablet terminal), or, for instance, a mobile processing apparatus (e.g., a tablet terminal, a dedicated terminal) provided at a shopping cart, a shopping basket or a shopping bag, or a shopping tool (e.g., a tool lent by a store, e.g., a store-lending tablet terminal or a dedicated scanning device (e.g., MC17 handheld retail mobile computer made by Motorola, Inc.)).

As described in the (2) “position information and time acquisition method” in step 204 in FIG. 2, the function that can identify that the target customer passes through the certain place in the store or across the stores may be a function of acquiring position information (e.g., which may be information represented in two-dimensional or three-dimensional coordinate axes) or a position information ID (e.g., which may be information acquired by converting information represented in two-dimensional or three-dimensional coordinate axes into a specific numbers, symbols, or a combination thereof) from position information transmitting devices installed on the ceiling, floor or shelves in the store, or a function of transmitting position information on the apparatus and the time when the apparatus is at each position, via receivers installed in the store at, e.g., prescribed intervals or non-dense intervals, to a server (e.g., which may be the computer system (101)).

The computer system (101) can estimate multiple positions where the target customer is and time when the target customer is at the respective positions through the functions provided for the second apparatus.

FIG. 6B shows a different embodiment where the computer system (101) acquires position information on the second apparatus.

An embodiment (621) shown in an upper part of FIG. 6B indicates the case where the second apparatus transmits position information. Infrared light sensors are installed on the ceiling at positions denoted as observation points a to n. In response to the customer passing through a range covered by the infrared light (e.g., a specific area (e.g., a rectangle, a circle, a point), e.g., a specific line or a specific point), the infrared light sensors acquire the position of the second apparatus and the time thereof. For instance, a method of acquiring position information using SmartLocator® has been known as a method of acquiring position information using infrared sensors. An ultrasonic wave transmission device is installed on the ceiling at a position denoted by the observation point p. As the customer passes through or resides in a range (e.g., a specific area) capable of receiving ultrasonic waves from the ultrasonic wave transmission device (e.g., identification of presence from a certain time to a certain time), a microphone provided for the second apparatus captures ultrasonic waves and acquires the captured position and time.

An embodiment (631) shown in a lower part of FIG. 6B illustrates the case where the second apparatus acquires position information. LED illumination devices are installed on the ceiling at the observation points a to n. The LED illumination devices blink at a human-insensible speed and transmit position information. As the customer passes through the range capable of receiving the LED illumination device (e.g., a specific area (e.g., a rectangle, a circle, a point), e.g., a specific line or a specific point), the second apparatus receives blinking light, and measures the position on the basis of the received light. The ultrasonic wave transmission device is installed on the ceiling at the position denoted by the observation point p. As the customer passes through the range capable of receiving ultrasonic waves from the ultrasonic wave transmission device (e.g., through the specific area), the microphone provided for the second apparatus captures ultrasonic waves, and the second apparatus acquires the captured position and the time thereof.

The specific line may be an entrance/exit of an aisle or an entrance or an exit. The specific point may be, for instance, a point in front of a portion where a specific article is. The specific area may be, for instance, a specific article group retail space (e.g., around a vegetable retail space or around a liquor retail space).

An indoor positioning technique for acquiring position information usable for the third embodiment according to the present invention may be, for instance, any of methods by means of a Wi-Fi access point, an indoor global positioning system (GPS) (e.g., IMES or GPS repeater system), an ultrasonic waves, visible light, infrared light, iBeacon™, sensor integration, and autonomous navigation. All of these methods have been known to those skilled in the art.

FIG. 6A shows a flowchart for performing the process of estimating purchase behavior of the customer in the store or across the stores according to the third embodiment according to the present invention.

In step 601, the computer system (101) starts the process of estimating purchase behavior of the customer in the store or across the stores.

In step 602, the computer system (101) acquires POS information upon purchase of each article by the target customer, and the layout information on each store and the shelving allocation information on each store. The computer system (101) may acquire the POS information according to the foregoing (2) article information acquisition method.

The computer system (101) can acquire POS information from, for instance, the storing device (211) that stores article information. The computer system (101) can acquire the layout information on each store from, for instance, the storing device (212) that stores the layout information. The computer system (101) acquires the shelving allocation information on each store from, for instance, the storing device (213) that stores the shelving allocation information.

Step 603 is the same as step 403 illustrated in FIG. 4A. Accordingly, as to the details of step 603, see the description of step 403.

In step 604, the computer system (101) estimates the purchase order of articles by the target customer in the store or across the stores, and multiple positions of the target customer (which are shopping points and correspond to respective observation points provided in the store or across the stores) and time when this customer is at the respective positions, by comparing position information on the second apparatus of the target customer and POS information with layout information on each store and shelving allocation information on each store (information for acquiring position information on the article). The computer system (101) may acquire the position information on the second apparatus (i.e., the multiple positions of the target customer and time when the customer is at each position) according to the (2) “position information and time acquisition method” described in step 204 in FIG. 2. The computer system (101) estimates each shopping point (position) of the shopping customer on the basis of the estimated position information on the second apparatus, the POS information and the shelving allocation information.

In step 605, the computer system (101) starts estimation of the traffic line of the target customer (including the traffic line in the store, the traffic line across the stores, or combination thereof), on the basis of the layout information on each store and the shelving allocation information on each store, the purchase order of articles estimated in step 604, and multiple positions of the target customer and time corresponding to each position, and the previous path information (corresponding to the previous path information read in step 203 in FIG. 2).

In step 606, the computer system (101) estimates the traffic line according to the following (1′) “estimation process method (average speed method)” or (2′) “estimation process method (travel path history method)” or (3′) “estimation process method (travel distance minimizing method)”. The (1′) “estimation process method (average speed method)” is a method of estimating the travel path on the basis of the travel time in the store or across the stores. The (2′) “estimation process method (travel path history method)” is a method of estimating the travel path on the basis of the travel path histories of previous customers or previous target customers. The (3′) “estimation process method (travel distance minimizing method)” is a method of estimating the travel path on the basis of the travel distance in the store or across the stores.

(1′) The “estimation process method (average speed method)”: the computer system (101) estimates a roughly estimated path from entrance to checkout or from entrance to exit at the store (e.g., from the entrance to the exit) (including multiple checkouts), or a roughly estimated path from entrance to checkout or from entrance to exit across stores (including multiple checkouts in one store, or checkouts at respective stores) (hereinafter, referred to as an estimated path), by connecting the multiple positions in a time series manner so as to make the average speed constant as much as possible on the basis of the multiple positions (corresponding to multiple observation points) estimated in step 604 and the time when the customer is at each position. The computer system (101) may estimate the estimated path so as to approach a previous average travel speed. The computer system (101) may use, as the previous average travel speed, an average travel speed acquired from previous path information that the target customer travels in the store or across the stores, or previous path information on estimated travel thereof, or previous path information that one or more customers travel in the store or across the stores, or previous path information on estimated travel thereof.

Optionally, the computer system (101) further calculates the shopping point of the target customer on the basis of the POS information and the shelving allocation information. If the calculated shopping point does not exist on the estimated path, the estimated path can be modified so as to make the average speed between the observation points constant. If it is assumed that the target customer visits the shopping point multiple times, the computer system (101) may assume that, for instance, the customer purchases the article when the customer visits the shopping point last time. Note that the observation point or the shopping point is not a point in a strict sense, and the observation point may be an area of a retail space, entrance or checkout place, and the shopping point may be the retail space or area. As the area is made fine, the area becomes a point. On the contrary, as the area is made rough, the observation point or the shopping point has, for instance, a size acquired by quartering the store.

The computer system (101) may define, as a coefficient of the travel speed, whether a purchase is made or not at the retail space (the number of purchased and the amount of money of articles), or the properties of the article (e.g., the weight and size of the article, allergy information, or categories (e.g., food, clothes, furniture))), on each retail space (path) to be passed. This is because it is assumed that purchase of articles, or the amount of money for articles that the customer tried to purchase or purchased being large increases the staying time at the retail space. Defining the coefficient of the travel speed improves the accuracy of estimating the path. In the estimation, it can be considered that defining the coefficient of the travel speed reduces the speed a little at a retail space whose products require deliberate consideration, e.g., a jewelry retail space, a furniture retail space or a large consumer electrical appliance retail space, or greatly reduces the passing speed during purchase of articles at such a retail space.

A technique used for, e.g., a car navigation system may be used as a connecting technique of making the average speed constant. As to the technique used for the car navigation system, see e.g., the foregoing JP2004-198165A.

(2′) The “estimation process method (travel path history method)”: the computer system (101) performs the following processes using the shopping point (position) estimated from the POS information and the shelving allocation information, and the time detected by the sensor, and information on the sensor position. The computer system (101) retrieves previous path information that the target customer traveled in the store or across the stores or previous path information on estimated travel thereof, or previous path information that one or more customers other than the target customer traveled in the store or across the stores or previous path information on estimated travel thereof, and extracts previous path information including the observation point and the shopping point that can be considered similar. The computer system (101) adopts a piece of path information identical to path information having the highest similarity among pieces of the extracted path information.

The computer system (101) may acquire output in a manner similar to the procedures 1 to 5 of (2) the “estimation process method (travel path history method)” shown in step 406 in FIG. 4A. In the case of presence of shopping information including path information actually measured in the store or across the stores, the computer system (101) can utilize the shopping information. (3′) The “estimation process method (travel distance minimizing method)”: the computer system (101) acquires a roughly estimated path from entrance to checkout in the store or across the stores by connecting the multiple positions in a time series manner at the shortest distance on the basis of the POS information and the multiple positions estimated in step 604 and the time when the customer is at each position.

In step 606, the path that can most appropriately describe the set of partial paths of the procedure 1 has been described. However, the traffic line may be estimated optionally according to one or more conditions (weighting) shown in the following (a) to (d): (a) in a case where pieces of path information representing different travel paths having high similarity are extracted, the previous path information on the target customer is more preferentially selected than the previous path information on the other customers; (b) in a case where pieces of path information representing different travel paths having high similarity are extracted, the previous path information on one or more customers with an article belonging to the same shopping category or with the same or similar purchased article is preferentially selected; (c) in a case where pieces of path information representing different travel paths having high similarity are extracted, the previous path information on one or more customers with the same or similar characteristics of customers, e.g., the age, gender, or travel speed of the target customer is preferentially selected; and (d) in a case where pieces of path information representing different travel paths having high similarity are not extracted, a travel path with a shopping point of the acquired travel path reduced at least by one is compared with the previous path information, and path information representing travel paths having high similarity is preferentially selected. The preferential selection may be performed by, for instance, attaching a preferential tag to the preferentially selected path information.

In step 606, the path that can most appropriately describe the set of partial paths in the procedure 1 in (2) “estimation process method (travel path history method)” shown in step 406 in FIG. 4A has been estimated. However, if a gap occurs in the description even by all means, the computer system (101) may optionally modify the layout information on each store or the shelving allocation information on each store. For instance, the case of difficulty to estimate the traffic line on a certain article at a small probability may be a case where the specific article is arranged at a place different from that of the shelving allocation information, a case where the customer returns the specific article to a position different from the original position for cancellation, a case where the article tag associated with the specific article is the article tag of another article, or a case where an employee displays the specific article at a position different from the position where the article should be displayed. For instance, the specific article is placed only at a place different from that of the shelving allocation information, all the traffic lines estimated on the customer having purchased the specific article indicate abnormality. Alternatively, if the specific article is placed also at a place different from that of the shelving allocation information, the traffic line (i.e., the traffic lines of some customers) estimated on a customer having the article placed on the different position indicates abnormality. In such cases, in consideration of the shelving allocation information on each store, the computer system (101) can assume that or change such that the position information on the specific article indicates another appropriate position, or register the information so as to indicate multiple positions, thereby allowing the abnormal traffic line to be modified to be a normal traffic line.

Steps 607 to 611 are identical or similar to steps 407 to 411 illustrated in FIG. 4A, respectively. Accordingly, as to the details of steps 607 to 611, see the description of steps 407 to 411. In step 612, the computer system (101) finishes the process of estimating purchase behavior of the customer in the store or across the stores.

FIG. 6C is a diagram showing an example of estimating the traffic line of the target customer according to the third embodiment according to the present invention. A screen (641) is a diagram showing estimation of the traffic line in the case where a target customer (651) enjoys shopping in a certain store.

(1) The target customer purchases articles in a certain store, and supplies payment for the articles using the POS terminal or the automatic checkout machine. According to this payment, the POS terminal or the automatic checkout machine generates POS information. The computer system (101) acquires the POS information (i.e., identification information on the purchased article). The computer system (101) acquires the layout information on each store and the shelving allocation information on each store. The computer system (101) can determine whether the target customer has visited the shopping points A to L and the observation points a to p or not on the basis of the acquired POS information. The articles 1, 2, 3, 4, 5, 6 and 7 are associated with shopping points J, B, G/B/A/E, A, J, H and F/K/D, respectively. Note that the product 3 and the product 7 are associated with multiple shopping points G/B/A/E and F/K/D, respectively.

(2) The computer system (101) estimates that the travel path of the target customer is p-l-k-j-m-d-d-m-g-h-i-n-n, and the time when the customer passed the observation points p-l-k-j-m-d-m-g-h-i-n-n, on the basis of presence or absence of visiting the observation points a to p and the visiting time.

(3) The computer system (101) estimates that the visiting order of the shopping points is J-I-B-A-B-G-H-K on the basis of the order of the observation points p-l-k-j-m-d-d-m-g-h-i-n-n.

(4) As with the article 7, even if the article belongs to multiple shopping points (F/K/D) but the target customer has visited only one shopping point thereamong, the computer system (101) can identify that the shopping point where the article 7 is purchased has been the shopping point K.

(5) As with the article 3, if the article belongs to the multiple shopping points (G/B/A/E) but the target customer has visited the multiple shopping points to which the article 3 belongs, the computer system (101) cannot identify the shopping point where the article 3 has been purchased.

(6) If the article belongs to a single shopping point, the number of purchased articles at the shopping point is one or less and the customer has visited the shopping point only once, the computer system (101) can identify the shopping order of purchasing the articles.

(7) As with the articles 1 and 5, if the multiple articles have been purchased at one shopping point, the computer system (101) cannot immediately identify the shopping order of the articles. That is, the computer system (101) can estimate that the order of purchasing the articles is any of the following orders: (a−1) 1—article 1—article 5—k; and (a−2) 1—article 5—article 1—k.

(8) As with the articles 2 and 4, if the target customer has purchased an article at a shopping point that the customer has visited at least two times, the computer system (101) cannot immediately identify the shopping order of the articles. That is, the computer system (101) can estimate that the order of purchasing the article 2 is any of the following orders: (b−1) j—article 2—m, m—g; (b−2) j—m, m—article 2—g; and (b−3) j—article 2—m, m—article 2—g (mainly, in the case of purchasing at least two articles). Likewise, the computer system (101) can estimate that, for instance, the order of purchasing the article 4 is any of the following orders: (c−1) m—article 4—d, d—m; (c−2) m—d, d—article 4—m; and (c−3) m—article 4—d, d—article 4—m (mainly, in the case of purchasing at least two articles).

(9) If the shopping order according to the conditions described in the foregoing (4) to (8) is not identified, the computer system (101) may identify a specific shopping order among the assumed shopping orders or the most appropriate shopping order according to the method shown in step 606 in FIG. 6A. That is, e.g., as to shopping order of the article 1 and the article 5, the computer system (101) calculates the staying time at the shopping point J and candidates for the travel path at the shopping point J on the basis of the time observed at the observation point 1 and the observation point k. It is then determined which one of (a−1) and (a−2) is more appropriate as the order of purchasing the article 1 and the article 5 in the time with reference to the previous path information. For instance, in the case of the short staying time at the shopping point J, (a−1), i.e., the order of the article 1 and the article 5 is estimated. Likewise, as to the shopping order of the article 2, the computer system (101) calculates the staying time at the stopping point B and the candidates for travel path at the observation point B on the basis of time observed at the observation points m (first time), d, m (second time), and determines which one of (b−1), (b−2) and (b−3) is most appropriate with reference to the previous path information. For instance, in the case and the like of significantly short staying time at the shopping point at the second time, it can be determined that the article has been purchased at the first staying, and the order of (b−1) is estimated. As to the article 4, likewise, for instance, it is assumed that (c−2) is estimated. Furthermore, optionally, even if it is estimated that the article 4 is purchased at the second staying at the shopping point A, in the case with a staying time sufficient enough to travel from the observation point m to the observation point d during the first staying at the shopping point A and where articles purchased therebefore and thereafter (here, the article 4 and the article 3) are related articles (e.g., competitive articles, or articles that are often purchased at the same time), the computer system (101) can sometimes estimate that the target customer has purchased comparing the article 3 and the article 4 with each other.

(10) If there is an unidentified shopping order even after determination described in the foregoing (9), the computer system (101) leaves the shopping order to be the unidentified shopping order, and can estimate the traffic line of the target customer using the identified part of the shopping order. For instance, as to the article 1, even if the purchase order with the article 5 has not been identified yet, the other purchased article and the purchase order with respect to the other article have been identified, and the computer system (101) can thereby estimate the traffic line of the target customer using the analyzed part of the shopping order.

On the screen (641), the case of one shopping trip in the single store having the layout shown on the screen (641) has been described as the example.

In the case of the single store, the embodiment of shopping is not limited to the above example. Alternatively, for instance, the various embodiments as described later may be assumed: (1) there is a case where even in a single store, payment for articles should be supplied on each floor where purchases are made; (2) there is a case where even with a certain size of the store, several tens of POS terminals are arranged side by side or arranged longitudinally and latitudinally; (3) there is a case where the customer does not stop at the POS terminal but can supply payment by online card settlement at any place instead; (4) there is a case where multiple shopping trips are made because of an article that the customer forgot to purchase after payment; and (5) there is a case where, if the store has a form of a single store but multiple tenants are on the same floor, payment for the articles should be supplied on a tenant-by-tenant basis. Even with any of such forms in the single store, the traffic line of the target customer in the single store can be estimated by the third embodiment according to the present invention.

In the case where the customer purchases articles across stores, i.e., multiple stores, for instance, various embodiments as described below may be assumed: (6) there is a case where payment for articles should be supplied on a store-by-store basis; (7) there is a case where even if articles are purchased across multiple stores, payment for the purchased articles can be integrally supplied at one time at general checkout place; and (8) there is a case where even if articles are purchased across multiple stores, payment for the articles at all stores can be integrally supplied at one time at any place. In any of such embodiments across stores, the traffic line of the target customer in the single store can be estimated by the third embodiment according to the present invention.

FIG. 7 is a diagram showing an example of purchase behavior (traffic line) of the target customer estimated according to the third embodiment according to the present invention.

A screen (701) is a diagram of estimation of the traffic line according to the third embodiment according to the present invention in the case where the target customer (711) enjoys shopping at a certain store. The computer system (101) has known that the target customer (711) purchased the articles 1, 2, 3, 4, 5, 6, and 7 on the basis of the POS information.

The computer system (101) estimates that the target customer (711) enters the store from the entrance/exit 2, travels in the order of the shelf with the article 1, the shelf with the article 5, the shelf with the article 2, the shelf with the article 4, the shelf with the article 3, the shelf with the article 4, the shelf with the article 6, and the shelf with the article 7, and then to the POS checkout machine 2. That is, the estimated traffic line of the target customer is A→B→C→D→E→F→G→H→I. The computer system (101) estimates that the article is purchased (taken into a cart) at a position where the customer travels, or optionally checks the article.

The purchase behavior of the target customer (711) is estimated as shown in the diagram (702) on the basis of the estimated traffic line of the target customer (711).

(1) The target customer (711) enters the store from the entrance/exit 2 and then travels to the shelf with the article 1 (path A). A sensor is attached to the entrance/exit so as to determine that the target customer enters the store.

(2) The target customer (711) takes the article 1 into the cart (estimated). Subsequently, the target customer (711) travels to the shelf with the article 5 (path B).

(3) The target customer (711) takes the article 5 into the cart (estimated). Subsequently, the target customer (711) travels to the shelf with the article 2 (path C).

(4) The target customer (711) takes the article 2 into the cart. Subsequently, the target customer (711) travels to the shelf with the article 4 (path D).

(5) The target customer (711) checks the article 4 (estimated). Subsequently, the customer travels to the shelf with the article 3 (path E).

(6) The target customer (711) takes the article 3 into the cart. Subsequently, the customer travels to the shelf with the article 4 (path F).

(7) The target customer (711) takes the article 4 into the cart (estimated).

Subsequently, the target customer (711) travels to the shelf with the article 6 (path G).

(8) The target customer (711) takes the article 6 into the cart. Subsequently, the target customer (711) travels to the shelf with the article 7 (path H).

(9) The target customer (711) takes the article 7 into the cart. Subsequently, the customer travels to the POS checkout machine 2 (path I).

As shown in the foregoing (5) and (7), the computer system (101) cannot correctly determine at which one of the time points of the foregoing (5) and (7) the article 4 is purchased. That is, if the target customer visits points in the same block multiple times, the computer system (101) cannot correctly determine whether the article is purchased at the first time, second time or thereafter. Thus, the computer system (101) can temporarily estimate that the target customer purchased the article, e.g., at the first time. The computer system (101) may further use the (1′) “estimation process method (average speed method)”, the (2′) “estimation process method (travel path history method)” or the (3′) “estimation process method (travel distance minimizing method)”, or refer to the previous shopping histories of one or more customers, and estimate which time the target customer purchased the article.

As shown in the forgoing (2) and (3), the computer system (101) cannot correctly determine the order of purchasing the article 1 and the article 5. That is, if the target customer purchased different articles in the same block, the computer system (101) cannot correctly determine the order of purchasing the articles. Thus, the computer system (101) can temporarily estimate that, for instance, the target customer can temporarily estimate that the customer purchased the articles in the order of the article 1 and the article 5, using the (1′) “estimation process method (average speed method)”, the (2′) “estimation process method (travel path history method)” or the (3′) “estimation process method (travel distance minimizing method)”. The computer system (101) may further use the method unused in the temporary estimation among the (1′) “estimation process method (average speed method)”, the (2′) “estimation process method (travel path history method)” and the (3′) “estimation process method (travel distance minimizing method)”, or refer to the previous shopping histories of the one or more customers, thereby estimating the order of purchasing the article 1 and the article 5 by the target customer.

Use of the traffic line estimated according to the third embodiment of the present invention allows, e.g., a manager (e.g., a store manager, a shopping center manager, a marketing company, manufactures of articles, wholesalers of articles) to correctly grasp in-store behavior of the customer in the store or across the stores. Accordingly, the manager can effectively configure the shelving allocation and the layout, and effectively control the traffic line of the customer in the store or across the stores, thereby allowing sales to be improved.

In the estimation of the traffic line according to the third embodiment of the present invention, the path that can most appropriately describe the set of partial paths is estimated. As described above, if description through use of the estimated traffic line causes a gap, the computer system (101) can modify the layout information on each store or the shelving allocation information on each store.

Furthermore, if description through use of the traffic line estimated according to the third embodiment of the present invention causes a gap, as to a fake of the article (e.g., an article that is not on sale is wrongly displayed on a shelf) and the wrongly arranged article (e.g., arrangement in a wrong retail space (e.g., different shelf) irrespective whether intentionally arranged or not), the fake of the article can be removed and the wrongly arranged article can be moved to a correct place.

The second embodiment and the third embodiment involved in the first embodiment according to the present invention have thus been described above. The first embodiment according to the present invention further involves embodiments in which the second embodiment and the third embodiment according to the present invention are combined (hereinafter, combined embodiments according to the present invention).

In the second embodiment according to the present invention, it is provided that the target customer scans the bar code on at least one article by an apparatus associated with the target customer. However, as to purchase behavior of an actual customer, there is some cases where payment for the article having not been scanned is supplied using the POS terminal or the automatic checkout machine without scanning the article (i.e., scanning the bar code of the article having not been scanned). In such cases, the path from the article scanned before the article having not been scanned being purchased to the article having not been scanned being taken, and the path from the article having not been scanned to the article scanned after having not been scanned being taken are unknown. In such cases, as to the unknown paths, the computer system (101) can estimate the path from the article scanned before the article having not been scanned being purchased to the article having not been scanned being taken, and the path from the article having not been scanned to the article scanned after having not been scanned being taken, according to the third embodiment according to the present invention.

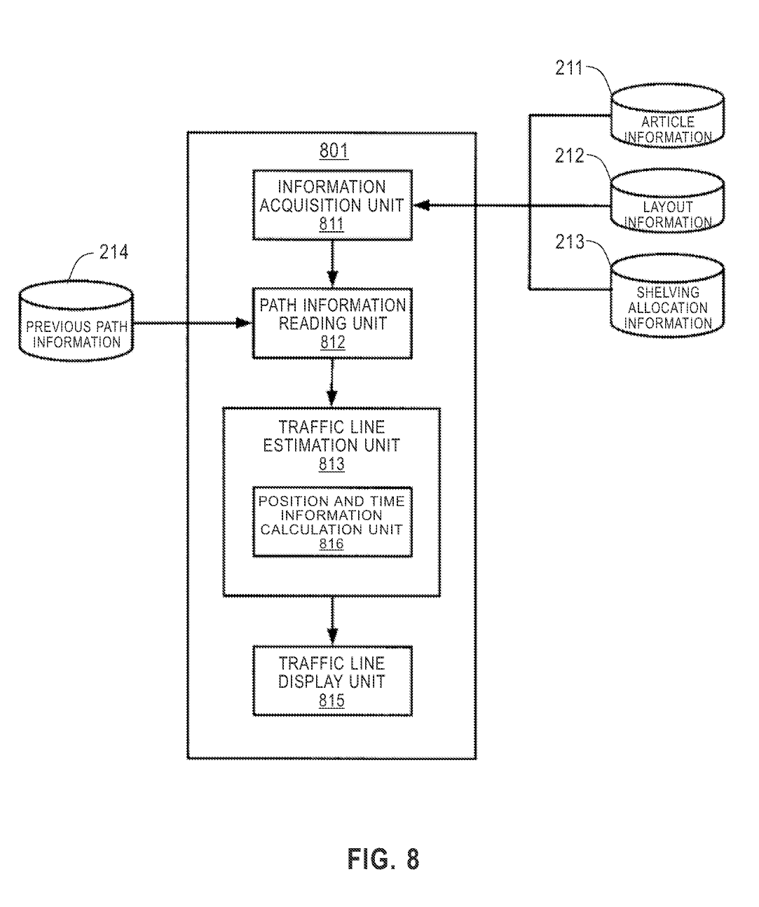

FIG. 8 is a diagram showing an example of a functional block diagram of a computer that preferably has the hardware configuration according to FIG. 1 and executes the embodiment of the present invention according to the flowcharts of FIGS. 2, 4A and 6A. Hereinafter, a “unit” may be read as “means”.

A computer system (801) may correspond to the computer system (101) shown in FIG. 1. The computer system (801) includes an information acquisition unit (811), a path information reading unit (812) and a traffic line estimation unit (813), and optionally further include a traffic line display unit (815). The information acquisition unit (811) acquires article information on at least one article that the target customer purchases or tries to purchase in the store or across the stores, the layout information on each store, and the shelving allocation information on each store. The article information acquired by the information acquisition unit (811) may be identification information on the article that the target customer purchases or tries to purchase, and the time when the identification information is read, which are acquired from the apparatus associated with the target customer.

The article information acquired by the information acquisition unit (811) may be identification information on the article that the target customer purchases. If the article information is the identification information on the article that the target customer purchases, the information acquisition unit (811) may acquire the position information on the target customer and the time when the target customer is at each position, from the apparatus provided in the store or across the stores or the apparatus associated with the target customer.

The information acquisition unit (811) may execute the process in step 202 in FIG. 2, the processes in steps 402 to 404 in FIG. 4A, and the processes in steps 602 to 604 in FIG. 6A. The path information reading unit (812) reads at least one piece of path information from between (b−1) previous path information in the store or across the stores where one or more customers traveled or previous path information on estimated travel thereof, and (b−2) previous path information in the store or across the stores where the target customer traveled or previous path information on estimated travel thereof.

The path information reading unit (812) may execute the process in step 203 in FIG. 2, a step of acquiring previous path information in step 405 in FIG. 4A, and a process of acquiring previous path information shown in step 605 in FIG. 6A.

The traffic line estimation unit (813) estimates the traffic line of the target customer in the store or across the stores, according to the tendency acquired from the path information read by the path information reading unit (812), on the basis of each piece of the information acquired by the information acquisition unit (811).

The traffic line estimation unit (813) (c3−1) may acquire each piece of the information acquired by the information acquisition unit (811), and the travel path of the target customer in the store or across the stores on the basis of the layout information or the shelving allocation information, (c3−2) estimate at least one purchase order of articles that the target customer purchases on the basis of each piece of the information and the travel path acquired by the information acquisition unit (811), and (c3−3) estimate the traffic line of the target customer in the store or across the stores, according to the tendency acquired from path information read by the path information reading unit (812), on the basis of each piece of the information acquired by the information acquisition unit (811).

The traffic line estimation unit (813) may execute the process shown in step 204 in FIG. 2, the processes shown in steps 406 to 408 in FIG. 4A, and the processes shown in steps 606 to 608 in FIG. 6A. The traffic line estimation unit (813) may include a position and time information calculation unit (816).

The position and time information calculation unit (816) (c2−1) may calculate the position information on the target customer and the time when the target customer is at each position, on the basis of the identification information on the article that the target customer purchases or tries to purchase, the time when the identification information is read, which are acquired from the apparatus associated with the target customer, and the layout information or the shelving allocation information.

The traffic line estimation unit (813) (c2−2) may estimate the traffic line of the target customer in the store or across the stores, according to the tendency acquired from the path information read by the path information reading unit (812), on the basis of each piece of the information acquired by the information acquisition unit (811), and the position information and the time calculated for the target customer.

The traffic line display unit (815) visualizes the traffic line estimated by the traffic line estimation unit (813), or a traffic line acquired by modifying the traffic line, for instance, on the screen. The traffic line display unit (815) may execute the process shown in step 205 in FIG. 2, the process shown in step 409 in FIG. 4A, and the process shown in step 609 in FIG. 6A.

What is claimed is:

1. A method of estimating purchase behavior of a customer in a store, the method causing a computer system to execute the steps of:
acquiring article information on at least one article that a target customer purchases or tries to purchase in the store, layout information on the store, and shelving allocation information on the store;
reading at least one of:
previous path information on estimated travel of one or more customers in the store, and
previous path information on estimated travel of the target customer in the store; and
estimating a traffic line of the target customer in the store, according to a tendency acquired from the path information read in the reading step, based on each piece of information acquired in the acquiring step.

2. The method according to claim 1, wherein the article information is acquired from an apparatus associated with the target customer and comprises:
identification information on the at least one article that the target customer purchases or tries to purchase, and
time information when the identification information is read; and
estimating the traffic line further comprises:
calculating position information on the target customer and time information when the target customer is at each position, based on the identification information on the at least one article that the target customer purchases, the time information when the identification information is read, and the layout information, and
estimating the traffic line of the target customer in the store according to the tendency acquired from the path information read in the reading step, based on each piece of the information acquired in the acquiring step, and the position information and the time information calculated for the target customer.

3. The method according to claim 1, wherein the article information is identification information on the at least one article that the target customer purchases,
the acquiring step further comprises:
acquiring position information on the target customer and time information when the target customer is at each position, from an apparatus installed in the store, and
estimating the traffic line further comprises:
acquiring a travel path of the target customer in the store or across the stores from each piece of the information acquired in the acquiring step, and the layout information, and
estimating at least one purchase order of the at least one article that the target customer purchases, based on each piece of the information acquired in the acquiring step and the acquired travel path.

4. The method according to claim 3, wherein estimating the traffic line further comprises:
calculating the position information on the target customer and the time information when the target customer is at each position, based on the acquired travel path and the estimated purchase order, and
wherein estimating the traffic line comprises:
estimating the traffic line of the target customer in the store, according to the tendency acquired from the path information read in the reading step, based on each piece of the information acquired in the acquiring step, and the position information and the time information calculated for the target customer.

5. The method according to claim 2, wherein the estimating the traffic line comprises:
calculating an average travel speed between two points in the store, based on the path information read in the reading step, and
estimating the traffic line of the target customer using the position information and the time information calculated for the target customer, such that the travel speed of the target customer between the two points in the store approaches the calculated average speed.

6. The method according to claim 2, wherein the path information read in the reading step is divided into a set of partial paths, and
wherein the estimating the traffic line comprises:
calculating a weight for a path cost that describes the set of partial paths most appropriately, and
estimating a path of the target customer connecting two points in the store, using the weight for the path cost, and the position information and the time information calculated for the target customer.

7. The method according to claim 6, wherein the step of estimating the path comprises:
estimating a path minimizing the weighted path cost as the traffic line of the target customer by solving a shortest path problem.

8. The method according to claim 6, wherein the estimating the path further comprises:
in a case where same articles X are arranged at different places and the target customer makes purchase in an order of an article A, an article X, and an article B, estimating that the target customer tries to purchase the article X at a place minimizing a sum of a path cost from a place where the target customer tries to purchase the article A to a place where the target customer tries to purchase the article X and a path cost from the place where the target customer tries to purchase the article X to a place where the target customer tries to purchase the article B.

9. The method according to claim 6, wherein the set of the partial paths is at least one of:
a partial path from an entrance or a cart or basket depot of the store to a position where the target customer tries to purchase a certain article first,
a partial path from a position where the target customer tries to purchase a certain article to a position where the target customer tries to purchase a next article, and
a partial path from a position where the target customer tries to purchase a certain article lastly to a checkout place of the store.

10. The method according to claim 3, wherein the estimating the traffic line:
comparing the acquired travel path with the path information read in the reading step, and
extracting path information representing a travel path having high similarity, and
estimating the traffic line of the target customer in the store, based on the extracted path information.

11. The method according to claim 10, wherein the estimating the traffic line comprises:
in a case where pieces of the path information representing different travel paths having high similarity are extracted, estimating the traffic line of the target customer in the store or across the stores, based on the path information representing the traffic line frequently included in the path information.

12. The method according to claim 10, wherein estimating the traffic line comprises:
in a case where pieces of the path information representing different travel paths having high similarity are extracted, selecting path information on the target customer rather than path information on other customers, and
estimating the traffic line of the target customer in the store based on the selected path information.

13. The method according to claim 10, wherein estimating the traffic line comprises:
in a case where pieces of the path information representing different travel paths having high similarity are extracted, selecting path information on one or more customers with a similar shopping category, and
estimating the traffic line of the target customer in the store based on the selected path information.

14. The method according to claim 10, wherein the estimating the traffic line comprises:
in a case where pieces of the path information representing different travel paths having high similarity are extracted, selecting path information on one or more customers with travel speed similar to that of the target customer, and
estimating the traffic line of the target customer in the store based on the selected path information.

15. The method according to claim 10, wherein estimating the traffic line comprises:
in response to no travel path with high similarity being extracted by the comparison, comparing a travel path with a shopping point of the acquired travel path reduced at least by one with the path information read in the reading step, and
extracting path information representing a travel path having high similarity, and
estimating the traffic line of the target customer in the store based on the extracted path information.

16. A computer system estimating purchase behavior of a customer in a store, comprising:
an information acquisition unit of acquiring article information on at least one article that a target customer purchases in the store, layout information on the store, and shelving allocation information on the store;
a path information reading unit configured to read at least one of:
previous path information on actual travel of one or more customers in the store, and
previous path information on actual of the target customer in the store; and
a traffic line estimation unit configured to estimate a traffic line of the target customer in the store, according to a tendency acquired from the path information read by the path information reading unit, based on each piece of the article information acquired by the information acquisition unit.

17. The computer system according to claim 16, wherein the article information is acquired from an apparatus associated with the target customer and comprises:
identification information on at least one article that the target customer tries to purchase, and time information when the identification information is read, and
the traffic line estimation unit is configured to:
calculate position information on the target customer and time information when the target customer is at each position, based on the identification information on the at least one article that the target customer purchases or tries to purchases, the time information when the identification information is read, and the shelving allocation information, and
estimate the traffic line of the target customer in the store, according to a tendency acquired from the path information read by the path information reading unit, based on each piece of the information acquired by the information acquisition unit, and the position information and the time information calculated for the target customer.

18. The computer system according to claim 16, wherein the article information is identification information on the at least one article that the target customer purchases,
wherein the information acquisition unit is configured to:
acquire position information on the target customer and time information when the target customer is at each position, from an apparatus installed in the store or across the stores or an apparatus associated with the target customer, and
the traffic line estimation unit is configured to:
acquire a travel path of the target customer in the store from each piece of the information acquired by the information acquisition unit, and the shelving allocation information, and
estimate at least one purchase order of the at least one article that the target customer purchases, based on each piece of the information acquired by the information acquisition unit and the acquired travel path.

19. The computer system according to claim 18, wherein the traffic line estimation unit is configured to:
calculate the position information on the target customer, and time information when the target customer is at each position, based on the acquired travel path and the estimated purchase order, and
estimate the traffic line of the target customer in the store or across the stores, according to a tendency acquired from the path information read by the path information reading unit, based on each piece of the information acquired by the information acquisition unit, and the position information and the time information calculated for the target customer.

20. A computer program product comprising a computer readable medium and a program code for the system of estimating purchase behavior of a customer in a store on the computer readable medium and defining the system of claim 16.
